(19) United States
(12) Patent Application Publication
(10) Pub. No.: US 2011/0075943 A1
(43) Pub. Date: Mar. 31, 2011

(54) IMAGE PROCESSING APPARATUS

(76) Inventor: Takahiro MINAMI, Osaka (JP)

(21) Appl. No.: 12/893,918

(22) Filed: Sep. 29, 2010

(30) Foreign Application Priority Data
Sep. 30, 2009 (JP) 2009-227443

(51) Int. Cl. G06K 9/36

(52) U.S. Cl. 382/233; 382/244

(57) ABSTRACT

An image processing apparatus has a storage unit for storing uncompressed data, a compression processing unit for performing lossless compression and lossy compression on the uncompressed data, a memory controller for reading the uncompressed data from the storage unit and writing compressed data compressed by the compression processing unit and a control unit for controlling transfer of the uncompressed data stored in the storage unit to the compression processing unit, wherein the compression processing unit has one DMA and simultaneously executes the lossless compression and the lossy compression, and wherein the control unit uses the DMA to successively transfer a rectangular region, constituted by a predetermined number of pixels in a main scanning line direction and a predetermined number of pixels in a sub-scanning line direction, of the uncompressed data from the storage unit to the compression processing unit for each rectangular region, and after uncompressed data on a main scanning line is transferred, the control unit moves in the sub-scanning line direction within one rectangular region, and the uncompressed data is transferred such that uncompressed data on a subsequent main scanning line is transferred, whereby the compression processing is successively performed on data in each rectangular region transferred by the compression processing unit.

### CROSS-REFERENCE TO RELATED APPLICATION

This application is related to Japanese Patent Application No. 2009-227443 filed on Sep. 30, 2009, whose priority is claimed under 35 USC §119 and the disclosure of which is incorporated by reference in its entirety.

### BACKGROUND OF THE INVENTION

1. Field of the Invention

The present invention relates to an image processing apparatus, and more particularly to an image processing apparatus having a function suitable for compressing and decompressing data including texts, graphics, pictures, and the like in a mixed manner.

2. Description of the Related Art

In digital apparatuses handling image data including still images and moving images, improvement of compression rate and improvement of image quality are important factors that are always demanded.

However, the compression rate and the image quality are of contradictory nature. In general, when the compression rate is increased, the image quality is likely to deteriorate, and when the image quality is increased, the compression rate is likely to decrease.

Accordingly, various kinds of techniques have been developed to increase the compression rate while suppressing deterioration in the image quality.

For example, there is a method including steps of analyzing features of image data in units of pixels or regions, extracting features such as pictures, texts, halftone dots, determining regions corresponding to the extracted features, and changing a compression method in each region based on a region determination result.

More specifically, one piece of targeted image data is divided into regions based on the region determination result. In a region determined to be a picture region, compression processing is performed according to lossy compression methods such as JPEG, JPEG2000, and JPEG-XR. In a region determined to mainly include texts, compression processing is performed according to lossless compression method such as run lengths method, MH, MR, MMR, and JBIG used for facsimile transmission. In other words, compression processing is performed according to an appropriate, different method in each region.

In the lossless compression method, when data is obtained in a main scanning direction to process successive pixels in order, change in density is more likely to decrease, which enables improving the compression rate. However, it is necessary to similarly obtain instruction data (attribute of image data) attached with image data in order to achieve such successive processing. Herein, the instruction data is data meaning a feature of an image such as the attribute of the image data, for example, a picture region, a text region, and a color/monochrome region.

In contrast, in the lossy compression method, compression processing is usually performed by obtaining data in units of rectangular regions, and instruction data is obtained according to a method different from the lossless compression.

When one piece of image data is compressed, a plurality of different processings are executed. Therefore, the image data as well as the instruction data attached therewith are compressed by a plurality of compressing processings using many DMAs, for example, four DMAs.

Further, Japanese Unexamined Patent Publication No. 2002-328881 discloses an image processing apparatus capable of reducing a buffer capacity in an image processing module to a small capacity approximately in units of blocks. In this image processing apparatus, image data is transferred in units of blocks by one DMA transfer, and image processing is performed in units of blocks. Then, after processing of one horizontal line is finished, a vertical line is moved, and processing is performed on a new horizontal line.

However, in a case where many DMAs are used to perform compression processing as in the conventional example, a large-scale circuit is required for the compression processing, and a main memory (DRAM) is accessed many times, which causes a squeeze on a band width of a main memory interface.

Further, in the image processing apparatus described in Japanese Unexamined Patent Publication No. 2002-328881, processings in units of blocks enable reducing the buffer capacity. However, execution of a plurality of different images compression processings is not taken into consideration in Japanese Unexamined Patent Publication No. 2002-328881.

Accordingly, in a case where different compression processings are executed, it is necessary to separately execute compression processings for respective image data in units of blocks, and it is difficult to commonly use a circuit. Therefore, a large-scale circuit is needed to cope with different compression processings.

### SUMMARY OF THE INVENTION

The present invention provides an image processing apparatus including: a storage unit for storing uncompressed data; a compression processing unit for performing lossless compression and lossy compression on the uncompressed data; a memory controller for reading the uncompressed data from the storage unit and writing compressed data compressed by the compression processing unit; and a control unit for controlling transfer of the uncompressed data stored in the storage unit to the compression processing unit, wherein the compression processing unit has one DMA and simultaneously executes the lossless compression and the lossy compression, and wherein with respect to a rectangular region constituted by a predetermined number of pixels in a main scanning line direction and a predetermined number of pixels in a sub-scanning line direction, the control unit uses the DMA to successively transfer the uncompressed data by the rectangular region in such a manner that transferring the uncompressed data on one main scanning line in the rectangular region is followed by shifting in the sub-scanning line direction to transfer the uncompressed data on the next main scanning line in the rectangular regions, and controls the compression processing unit successively performs the compression processing of data for each rectangular region.

With this configuration, uncompressed data is transferred in units of predetermined rectangular regions without distinguishing lossless compression and lossy compression, and compression processing is performed in each of these rectangular regions. Therefore, in a compression method in which both of the lossless compression and the lossy compression are performed, a data transfer methods are unified, compared with conventional examples. Accordingly, only one DMA is used to transfer data, and an amount of access to a storage unit can be reduced. Therefore, a circuit configuration needed for compression processing can be reduced.

### BRIEF DESCRIPTION OF THE DRAWINGS

FIG. 1 is a block diagram illustrating a configuration of compression processing of a conventional image processing apparatus;

FIG. 2 is an explanatory diagram of a case where lossy compression processing is performed on image data in a conventional example;

FIG. 3 is a flowchart illustrating an embodiment of conventional compression processing;

FIG. 4 is an explanatory diagram illustrating data transfer from a DRAM to an SRAM in a conventional example;

FIG. 5 is an explanatory diagram illustrating data transfer from a DRAM to an SRAM in a conventional example;

FIG. 6 is an explanatory diagram illustrating replacing processing and data transfer to a lossy compression core in a conventional example;

FIG. 7 is an explanatory diagram illustrating conventional lossless compression processing;

FIG. 8 is a flowchart illustrating an embodiment of the conventional compression processing;

FIG. 9 is an explanatory diagram illustrating data transfer from a DRAM to an SRAM in a conventional example;

FIG. 10 is an explanatory diagram illustrating data transfer from a DRAM to an SRAM in a conventional example;

FIG. 11 is an explanatory diagram illustrating replacing processing and data transfer to a lossless compression core in a conventional example;

FIG. 12 is an explanatory diagram illustrating conventional lossless compression processing;

FIG. 13 is a flowchart illustrating an embodiment of the conventional compression processing;

FIG. 14 is an explanatory diagram illustrating of a case where instruction data is transferred from a DRAM to an SRAM in a conventional example;

FIG. 15 is a block diagram illustrating an embodiment of functional blocks relating to compression processing in an image processing apparatus according to the present invention;

FIG. 16 is a block diagram illustrating functional blocks of a compression processing module according to the present invention;

FIG. 17 is a flowchart illustrating an embodiment of the compression processing according to the present invention;

FIG. 18 is an explanatory diagram illustrating replacing processing and data transfer to a lossless compression core according to the present invention;

FIG. 19 is a timing chart illustrating arbitration processing performed by an arbiter according to the present invention;

FIG. 20 is an explanatory diagram for comparing a conventional example with an amount of data access according to the present invention;

FIG. 21 is a block diagram illustrating a configuration of decompression processing of a conventional image processing apparatus;

FIG. 22 is an explanatory diagram illustrating an embodiment of configuration blocks for performing conventional lossy decompression processing on image data;

FIG. 23 is a flowchart illustrating the conventional lossy decompression processing as shown in FIG. 22;

FIG. 24 is an explanatory diagram illustrating an embodiment of configuration blocks for performing conventional lossless decompression processing on instruction data;

FIG. 25 is a flowchart illustrating the conventional lossless decompression processing as shown in FIG. 24;

FIG. 26 is an explanatory diagram illustrating an embodiment of configuration blocks for performing conventional lossless decompression processing on lossless-compressed image data;

FIG. 27 is a flowchart illustrating the conventional lossless decompression processing as shown in FIG. 26;

FIG. 28 is an explanatory diagram illustrating an embodiment of conventional image data generation;

FIG. 29 is a diagram illustrating an embodiment of functional blocks for executing decompression processing according to the present invention;

FIG. 30 is a block diagram illustrating functional blocks of decompression processing according to the present invention; and

FIG. 31 is a flowchart illustrating the decompression processing according to the present invention.

### DESCRIPTION OF THE PREFERRED EMBODIMENTS

The present invention provides an image processing apparatus that performs data transfer using one DMA in a case where a plurality of image compression processings are performed on one piece of target image data, thus capable of reducing a scale of a circuit than conventional examples.

Moreover, there is provided the image processing apparatus, wherein the uncompressed data, which is to be compressed, stored in the storage unit, includes image data and instruction data associated with each pixel of the image data and indicating which of the lossless compression or the lossy compression is to be performed, and the DMA transfers the image data and the instruction data from the storage unit to the compression processing unit for each rectangular region, and the compression processing unit performs lossless compression on the transferred instruction data and performs the lossless compression or the lossy compression on the transferred image data based on the corresponding instruction data.

With this configuration, both of the instruction data and the image data used for executing compression processing including lossless compression and lossy compression in a mixed manner are respectively transferred for each rectangular region. Therefore, data transfer processings are unified to one processing, whereby an amount of access to a storage unit can be reduced, compared with conventional examples. Further, a hardware configuration can be reduced.

Moreover, the compression processing unit further includes an access arbitrating unit, and the access arbitrating unit performs, in a time-division manner, replacement processing for distinguishing image data that the DMA obtains from the storage unit so that image data to be lossless-compressed and image data to be lossy-compressed are distinguished and compressed.

With this configuration, compared with a case where time division processing is not performed in data replacing processing, a circuit configuration needed for compression processing can be reduced.

Further, the compression processing unit includes a first compression core for performing the lossless compression on the instruction data, a second compression core for performing the lossy compression on the image data to be lossy-compressed, and a third compression core for performing the lossless compression on the image data to be lossless-compressed, and each compression core performs the compression processing on the instruction data or the image data for each rectangular region respectively given.

With this configuration, each necessary compression processing can be executed in parallel on the image data and the instruction data to be compressed.

Moreover, the image processing apparatus further includes a decompression processing unit for performing lossless decompression and lossy decompression on compressed data, and wherein the decompression processing unit includes one DMA, a first lossless decompression core for performing lossless decompression processing on instruction data in the compressed data, a second lossless decompression core for performing the lossless decompression on the image data in the compressed data, and a lossy decompression core for performing the lossy decompression on the image data in the compressed data.

With this configuration, the decompression processing of the compressed data is performed using one DMA and a circuit needed by the lossless decompression or the lossy decompression. Therefore, in the decompression processing as well as the compression processing, an amount of data access can be reduced, and a circuit configuration can be reduced.

In embodiments described below, the compression processing unit according to the present invention corresponds to three compression modules (11-1, 11-2, 11-3). The storage unit corresponds to a DRAM. The control unit corresponds to a CPU. The access arbitrating unit corresponds to an arbiter. The first compression core corresponds to a lossless compression core 11-2. The second compression core corresponds to a lossy compression core 11-1. The third compression core corresponds to lossless compression cores (11-3R, G, B).

Further, the decompression processing unit corresponds to three decompression modules (101-1, 2, 3).

According to the present invention, in a case where an image processing including the lossless compression and the lossy compression in a mixed manner is performed, data to be compressed is transferred to the compression processing unit in units of predetermined rectangular regions regardless of whether the data is compressed by the lossless compression or the lossy lossless compression, and only one DMA performs the transfer processing. Therefore, an amount of data access to a storage unit storing data to be compressed is reduced, and a circuit configuration needed for compression processing can be reduced.

Embodiments of the present invention will be hereinafter described with reference to the drawings. However, it is to be understood that the present invention is not limited to the embodiments described below.

<Configuration of Image Processing Apparatus According to Conventional Art>

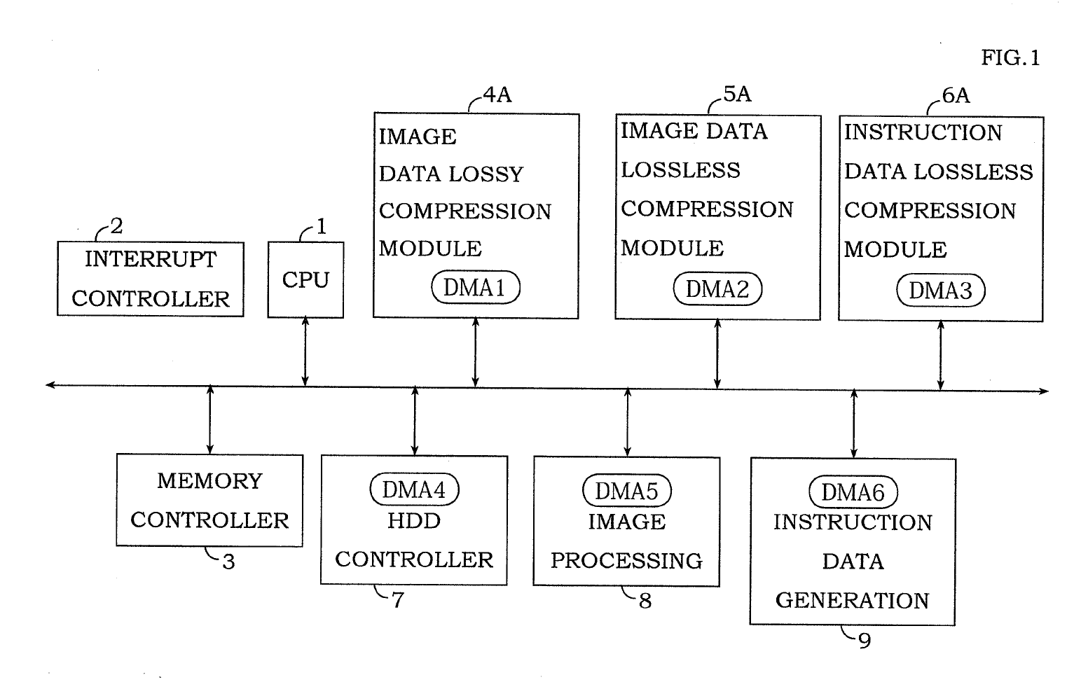

FIG. 1 is a block diagram illustrating a configuration of an essential portion of compression processing according to an embodiment of a conventional image processing apparatus.

A CPU 1 reads program data stored in a DRAM (a main memory, not shown) via a memory controller 3, and interprets read instructions, thus performing operation.

Examples of instructions include DMA start/end and interrupt processing. The CPU 1 controls an entire system by reading out the instructions in order.

An interrupt controller 2 receives an event signal from each functional block, and notifies an occurrence of event to the CPU 1.

For example, the event signal is a notification signal outputted to the interrupt controller 2 from a DMA block, such as a notification of DMA completion, or a notification of halt of DMA caused by an error of communication with a slave module.

Notification information of these notification signals is stored in a register in the interrupt controller 2, and the CPU 1 reads a corresponding register. Thus, these notification signals enable determining what kind of event has occurred. The CPU 1 determines a content of subsequent operation according to a type of the determined event.

The memory controller 3 is a module for controlling reading and writing operation on the connected DRAM device.

The memory controller 3 operates as a slave module, and performs reading or writing operation of data, which starts from a specified address and has a specified data size, to the DRAM device in response to requests given by each DMA and the CPU, i.e., a master module.

Data read in response to a reading request is transferred to the master that requested the data. Data to be written in response to a writing request is obtained from the master, and writing operation is performed on the DRAM device. In addition, refresh control is performed in order to prevent deletion of data in the DRAM.

An image processing module (DMA 5) 8 is a module having a DMA (Direct Memory Access) function and an image processing function. The image processing module (DMA 5) 8 obtains image data from the DRAM in response to a DMA start instruction given by the CPU 1, and saves the image data to an SRAM (not shown) serving as a data buffer.

Further, the image data stored in the SRAM is read, and image processing is performed in response to an instruction given by the CPU. Then, the processed image data is written to the SRAM serving as an output buffer.

The image processing is finished, and the DRAM 5 performs writing operation on the DRAM again.

When the above processing is repeated, and the processings on all pieces of the image data are finished, a completion notification is sent to the interrupt controller 2, and completion of the processing is notified to the CPU 1 via the interrupt controller 2.

For example, the image processing executed here is compression processing and decompression processing.

An instruction data generation module (DMA 6) 9 is a module having a DMA function and generating instruction data.

The instruction data is data for identifying a compression format described below.

Herein, first, image data is obtained from the DRAM in response to a DMA start instruction from the CPU 1, and is stored to the SRAM.

Subsequently, the image data stored in the SRAM is read, and image analysis is performed in response to an instruction given by the CPU. As a result of image analysis, 4 bit compression method instruction data (which may be simply referred to as instruction data) is generated for each pixel (one pixel is made of 24 bits constituted by RGB each having 8 bits).

That is, 4-bit compression instruction data is generated for one pixel made of 24 bits. For example, in a case of image data of 100 MB, a size of the instruction data is 16.7 MB. When instruction data generation processing is finished, the DMA 6 writes the generated instruction data to the DRAM. When all the instruction data generation processings are finished, the DMA 6 gives a completion notification to the interrupt controller 2 and completion of the processing is notified to the CPU 1 via the interrupt controller 2.

Herein, the image analysis means processings such as region determination. More specifically, the image analysis may be a conventional one, and a detailed description thereof will not be given.

For example, in a case of image data obtained from a digital camera, the image data is determined to be a picture region by analyzing image data. Accordingly, instruction data for performing lossy compression is generated.

An HDD controller (DMA 4) 7 is a module having a DMA function and performing reading or writing operation of the DRAM data to a hard disk HDD (not shown) in response to a DMA start instruction given by the CPU.

When all data transfers are finished, a completion notification is given to the interrupt controller 2, and completion is notified to the CPU 1 via the interrupt controller 2. Data processed here includes all pieces of data stored to the HDD, such as image data, instruction data, compressed data, program data, and the like.

An image data lossy compression module (DMA 1) 4A, an image data lossless compression module (DMA 2) 5A, an instruction data lossless compression module (DMA 3) 6A are modules which respectively have DMA functions and perform data compression process.

Operations of each of the modules will be described later in detail.

Each of these three blocks obtains image data and instruction data from the DRAM in response to a DMA start instruction given by the CPU 1. After compression processings of all pieces of data are finished, a completion notification is given to the interrupt controller 2, and completion is notified to the CPU 1 via the interrupt controller 2.

<Description of Compression Format>

Subsequently, compression formats will be described. Various kinds of methods have been suggested as compression formats of data.

Since different algorithms are used for different compression formats, compression rates and processing speeds are also different.

For example, compression fog mats such as JBIG and MMR are referred to as lossless compression formats, which are characterized in that when compressed (encoded) data is decompressed (decoded), exact original data can be obtained.

In contrast, once data is compressed according to JPEG, JPEG-2000, JPEG-XR, and the like, original data cannot be obtained after decompression. This is called lossy compression formats.

In the lossy compression formats, component/information having low sensitivities to human eyes are deleted to increase the compression rate, and accordingly, an amount of information is reduced. Therefore, in the lossy compression formats, original data cannot be obtained after decompression.

However, some compression formats can handle both of the lossless compression and the lossy compression. When lossy compression is performed, the compression rate increases. When the lossless compression is performed, the compression rate decreases.

When image data such as a picture is compressed by lossy compression in order to improve the compression rate, a problem of image quality deterioration is relatively small because the image data includes much high frequency component. However, when image data having a large amount of texts and patterns is compressed by lossy compression, image deterioration is conspicuous due to an influence of block noises or the like, and therefore, it is preferable to perform lossless compression.

Accordingly, a method for improving the compression rate while maintaining good image quality is used. In this method, image data is analyzed, and a compression format suitable for each pixel is determined.

<Description of Conventional Image Compression Processing>

Hardware operation of image compression processing using instruction data will be described below.

A lossless compression method is used to compress instruction data. Two methods, i.e., lossless compression and lossy compression methods, are used to compress image data according to instruction data.

In the lossy compression, a same format is used to compress not only the instruction data but also the image data for sake of simplicity, and a compression module successively performs compression processing on input data according to an order in which the data is inputted.

The lossless compression is successively processed in units of blocks. In the lossless compression, one compression unit includes totally 64 pixels constituted by 8 pixels in a main scanning direction and 8 pixels in a sub-scanning direction.

First, it is assumed that the DRAM stores the image data and the compression instruction data.

For example, the image data is stored with a starting address of 0x0000_{—}0000 in the DRAM, and a size of the image is 100 MB.

The instruction data is stored with a starting address of 0x1000_{—}0000 in the DRAM, and a size thereof is 16.7 MB.

The lossy-compressed image data is stored with a starting address of 0x2000_{—}0000. The lossless-compressed image data is stored with a starting address of 0x3000_{—}0000 (R component), a starting address of 0x4000_{—}0000 (G component), and a starting address of 0x5000_{—}0000 (B component). The lossless-compressed instruction data is stored with a starting address of 0x6000_{—}0000.

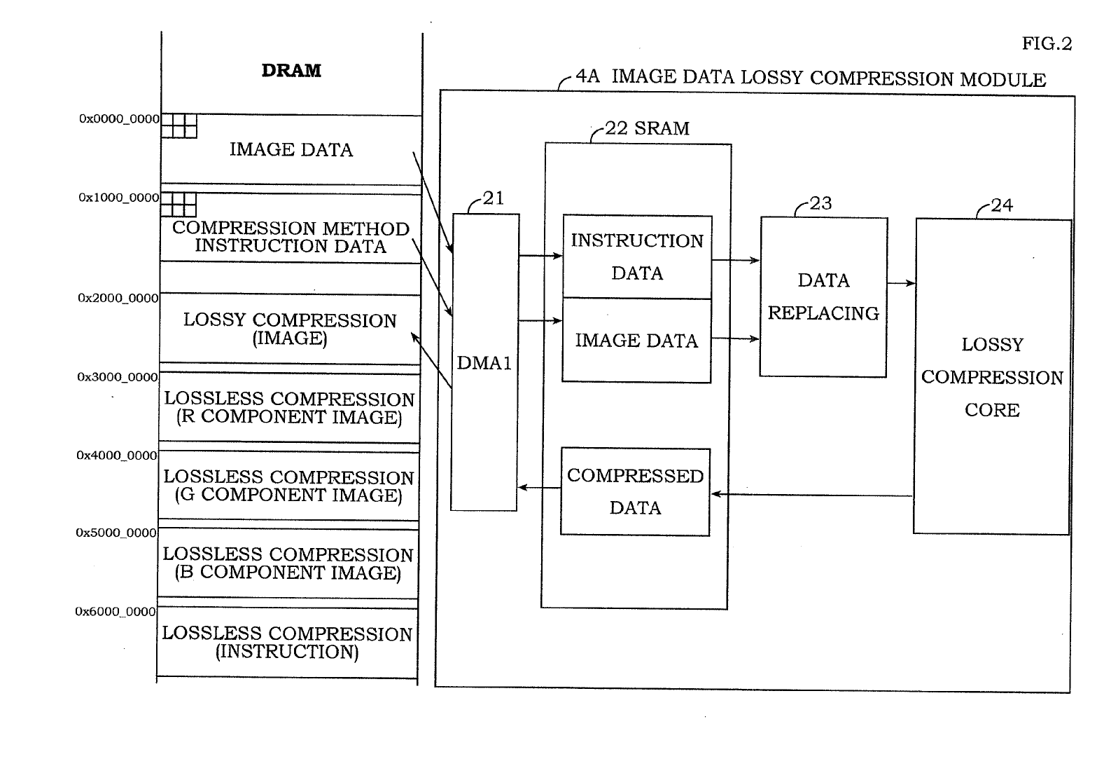

FIG. 2 is an explanatory diagram illustrating a conventional embodiment for performing lossy-compression on image data.

This lossy compression processing is a processing executed by an image data lossy compression module 4A as shown in FIG. 1. The lossy compression processing is mainly executed by hardware including a DMA module (DMA 1) 21 for reading image data and instruction data stored in the DRAM and writing compressed data, an SRAM 22 for buffering instruction data, image data, and compressed data, a data replacing module 23 for correcting image data according to a content of instruction data, and a lossy compression core 24.

Herein, sizes in the SRAM 22 are as follows. A size for storing image data is 24 bits/192 words (equivalent to 192 pixels). A size for storing instruction data is 4 bits/192 words (equivalent to 192 pixels).

In the lossy compression core 24, one processing unit is made of 64 pixels. Accordingly, three processing units (64×3) can be stored in the SRAM 22.

The SRAM 22 for storing compressed data is configured to be 64 bits/72 words.

The data replacing module 23 reads, for each pixel, data from the SRAM 22 storing the instruction data and the image data, performs pixel replacing processing according to the content of the instruction data, and outputs the data to the lossy compression core 24.

When the lossy compression core 24 receives 64 pixels of data, the lossy compression core 24 performs compression processing, and outputs compressed data.

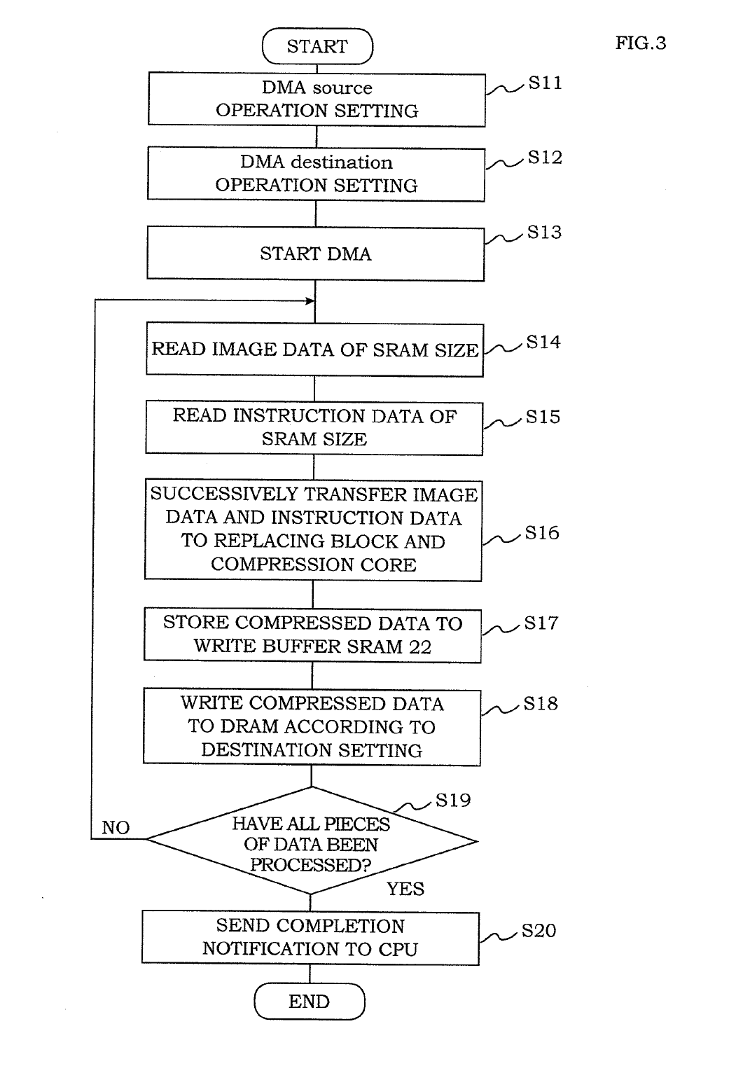

FIG. 3 is a flowchart illustrating the lossy compression processing as shown in FIG. 2.

In order to execute the lossy compression processing of FIG. 2, first, the CPU 1 needs to perform operation setting (S11 to S12).

In step S11, operation setting of a DMA source is made.

Herein, a position (address) of the DRAM from which the DMA 1 (21) obtains data and a data size to be processed are set. For example, this setting is automatically made by the CPU 1 based on a size of an original document and a state of use of the main memory.

For example, the starting address of the image data is set to 0x0000_{—}0000, and the starting address of the instruction data is set to 0x1000_{—}0000. A size of the image data and a size of the instruction data are the same. That is, the image data and the instruction data have 100 pixels in the main scanning direction and 100 lines in the sub-scanning direction.

Subsequently, in step S12, operation setting of a DMA destination is performed.

Herein, a position (address) of the DRAM to which the compressed data is stored is specified.

The lossy-compressed data is specified to be stored to 0x2000_{—}0000. A size thereof is not specified, since a size of each image is different. Similarly, this setting is also automatically made by the CPU 1 based on a size of an original document and a state of use of the main memory.

When the operation setting by the CPU 1 is finished, the CPU 1 starts the DMA 1 (21) in step S13.

When a DMA start instruction is given, the DMA 1 (21) starts processing for requesting data to be processed from the memory controller 3.

In step S14, first, the DMA 1 (21) reads the image data from the DRAM and stores the image data to the image data storage SRAM 22.

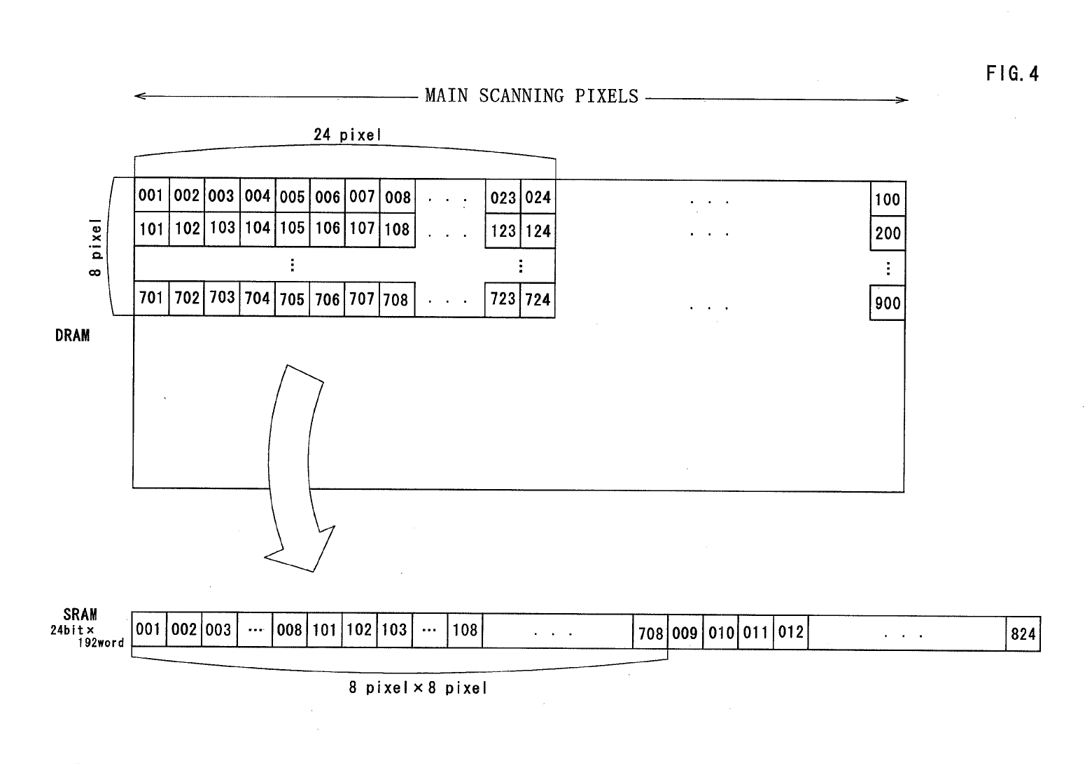

FIG. 4 is a conceptual diagram illustrating data acquisition from the DRAM to the SRAM 22.

Herein, the image data has 100 pixels in the main scanning direction (horizontal direction of the drawing), and the data is continuously stored in the DRAM as shown in an upper part of FIG. 4.

When lossy compression is performed in units of 8×8 pixels, the SRAM 22 has a capacity of three sets of 8×8 pixels. Therefore, rectangular region data (192 pixels) constituted by 24 pixels in the main scanning direction and 8 lines in the sub-scanning direction (vertical direction of the drawing) is obtained from the DRAM to the SRAM 22. At this time, the SRAM 22 stores pixel data as shown in FIG. 4.

Subsequently, in step S15, the DMA 1 (21) reads the instruction data from the DRAM, and stores the instruction data to the storage SRAM 22.

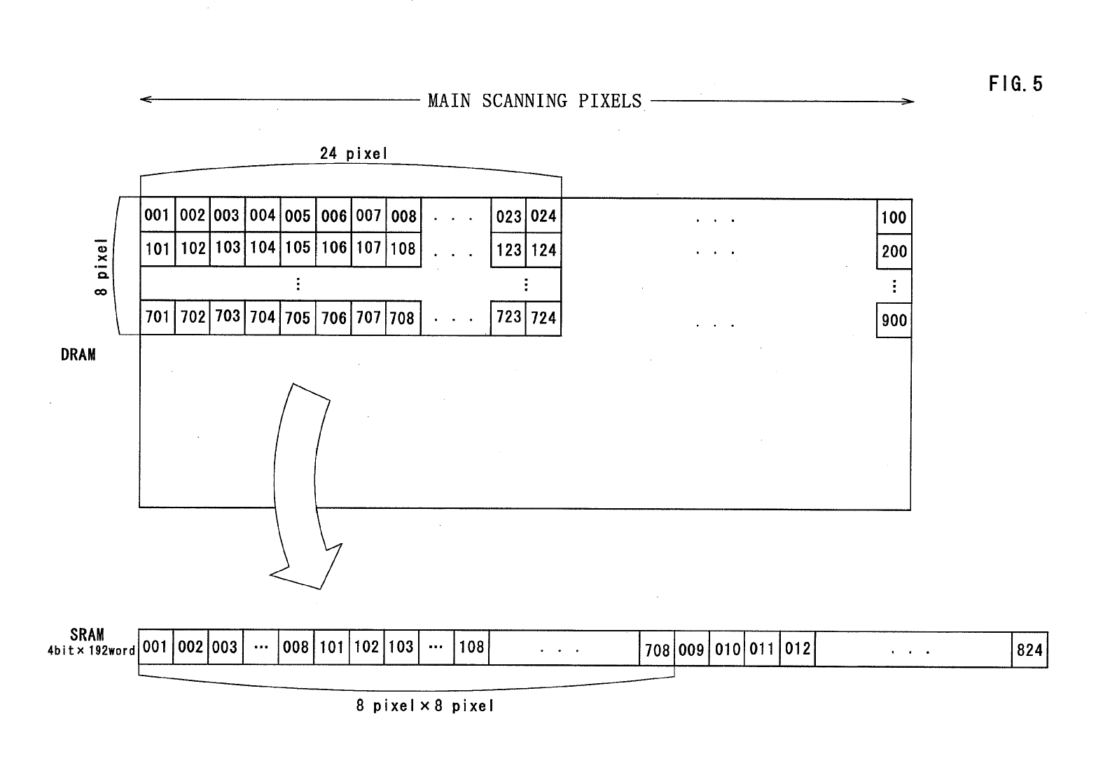

FIG. 5 is a conceptual diagram illustrating data acquisition from the DRAM to the SRAM 22.

The instruction data is also continuously stored from the starting address in a manner similar to the image data.

The necessary instruction data covers a rectangular region corresponding to the image region on which the lossy compression is executed. Therefore, data in the corresponding portion constituted by 24 pixels in the main scanning direction and 8 pixels in the sub-scanning direction is obtained and stored to the SRAM 22.

When writing of the image data and the instruction data to the SRAM 22 is finished, a completion notification is outputted from the DMA 1 module 21 to the data replacing module 23 in step S16. The data replacing module 23 starts replacing processing upon receiving the completion notification.

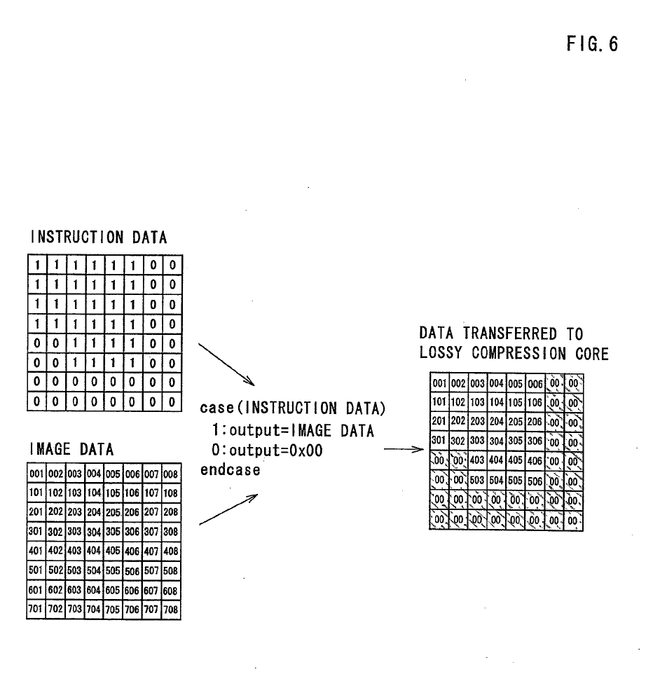

FIG. 6 is an explanatory diagram illustrating an embodiment of replacing processing.

First, the data replacing module 23 respectively obtains image data “001” and corresponding instruction data “1” from the SRAM 22. The instruction data includes values of 0 or 1. In the instruction data, 0 denotes a pixel on which lossless compression processing is performed, and 1 denotes a pixel on which lossy compression processing is performed.

Since the value “1” of the instruction data means the lossy compression processing, the image data is outputted to the lossy compression core 24 without any processing.

Subsequently, the instruction data “1” corresponding to image data “002” is read from the SRAM 22 in order, and the data processing is repeated.

In FIG. 6, when the image data “007” is processed, the instruction data value is “0”.

At this time, the instruction data value “0” means the lossless compression. Therefore, the image data “007” is replaced with “0x00”, and the replaced image data is outputted to the lossy compression core 24.

When this replacing processing is repeated totally 64 times for 8 pixels in the main scanning direction and 8 lines in the sub-scanning direction, the replaced data is transferred to the lossy compression core 24 as shown in a right side of FIG. 6.

For sake of simplicity, the data is simply replaced to “0x00” in the replacing processing. However, various kinds of methods are available to improve the image quality.

When data transfer to the lossy compression core 24 of FIG. 3 is finished, the compression core 24 executes compression processing, and stores a result to the compressed data storage SRAM 22 in step S17.

When the compression core 24 repeats 8×8 pixel processing three times, all the processings on the data obtained in the image data SRAM 22 are finished. Therefore, completion is notified to the DMA 1 module 21.

When the DMA 1 module 21 receives the completion notification from the lossy compression core 2, compressed data is written to the DRAM according to destination setting in step S18.

In step S19, processings from reading to writing of data performed by the DMA 1 (21) are repeated until all pieces of the data are lossy-compressed. When the processings are finished, a finish notification is sent to the CPU 1 in step S20.

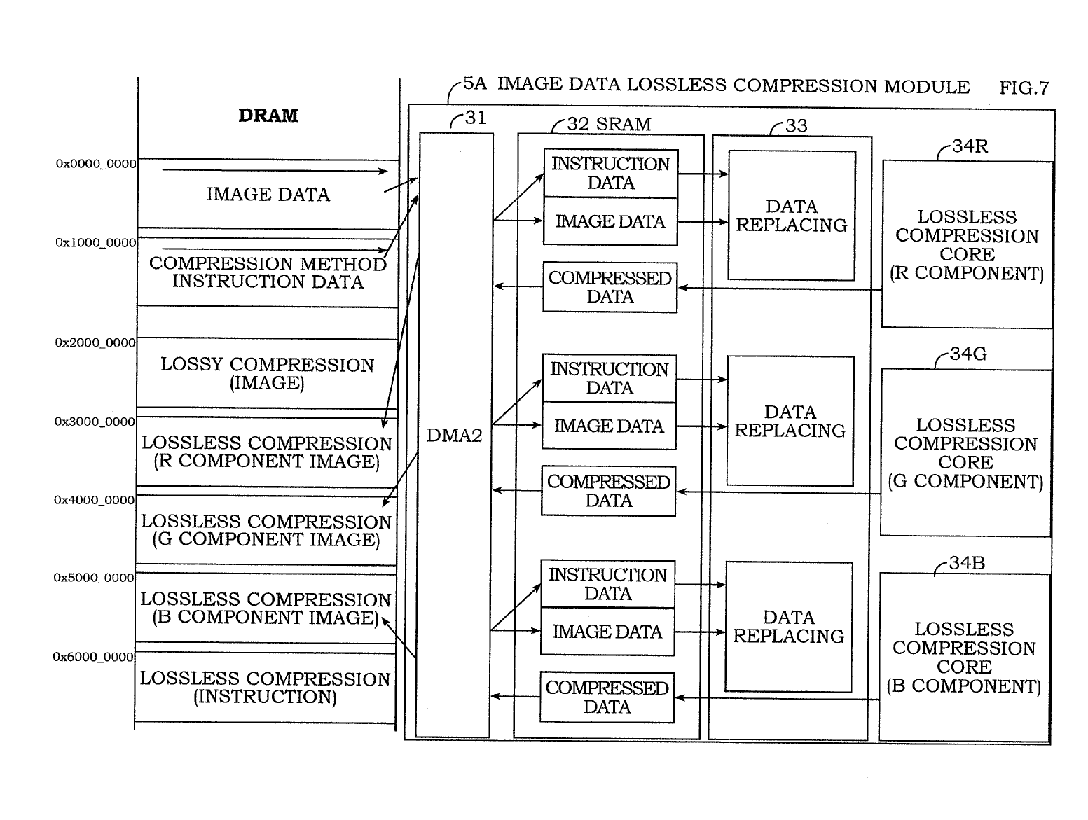

FIG. 7 is an explanatory diagram illustrating an embodiment for performing lossless compression processing on image data.

This lossless compression processing is processing executed by the lossless compression module 5A of FIG. 1.

A basic configuration is the same as a configuration of the lossy compression processing of FIG. 2.

However, the lossy compression core 24 of FIG. 2 is replaced with lossless compression cores (34R, 34G, 34B) for independently compressing respective color components of RGB. Accordingly, a configuration of an SRAM 32 includes three sets of 8 bits/192 words.

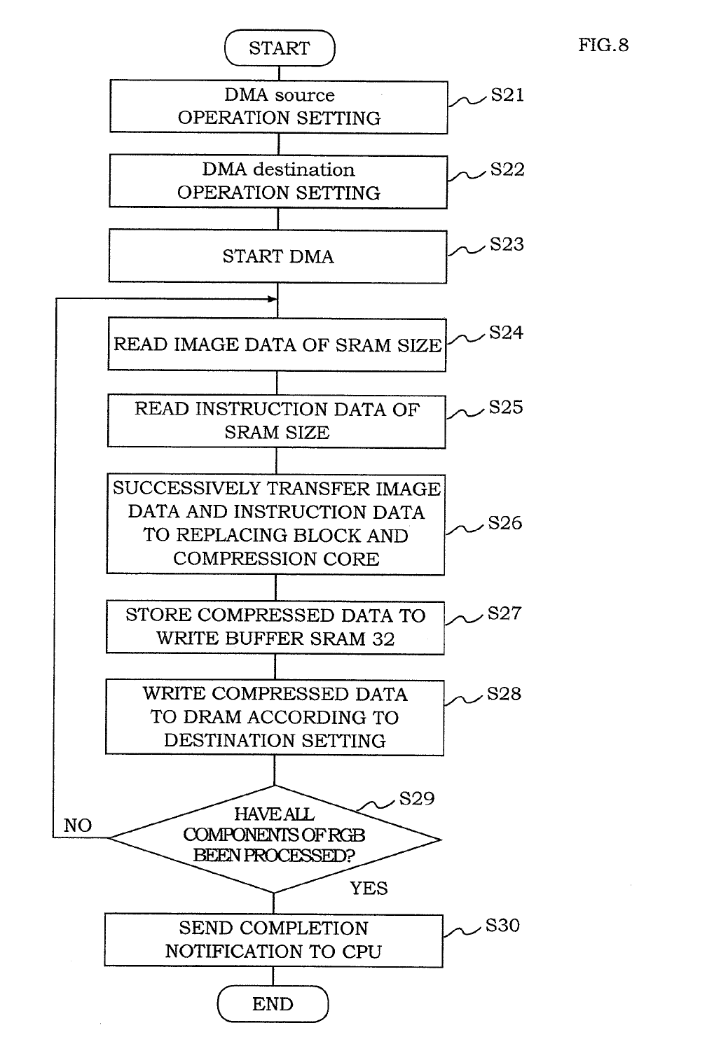

FIG. 8 is a flowchart illustrating the lossless compression processing of FIG. 7.

In order to execute the lossless compression processing of FIG. 7, first, the CPU needs to perform operation settings (S21, S22).

In step S21, operation setting of a DMA source is made. Herein, the starting address of the image data is set to 0x0000_{—}0000, and the starting address of the instruction data is set to 0x1000_{—}0000. The size of the image data and the size of the instruction data are the same. That is, the image data and the instruction data have 100 pixels in the main scanning direction and 100 lines in the sub-scanning direction.

The above settings are completely the same as the settings of the lossy compression processing. The same image data and the same instruction data are used to execute the lossless compression processing.

Subsequently, in step S22, operation setting of the DMA destination is performed.

Herein, a position (address) of the DRAM to which the compressed data is stored is specified.

An R region of the lossy-compressed data is specified to be stored to 0x3000_{—}0000. A G region thereof is specified to be stored to 0x4000_{—}0000. A B region thereof is specified to be stored to 0x5000_{—}0000. A size thereof is not specified, since a size of each image is different.

When the operation setting by the CPU 1 is finished, the CPU 1 starts the DMA 2 (31) in step S23.

When a DMA start instruction is given, the DMA 2 (31) starts processing for requesting data to be processed from the memory controller 3.

In step S24, first, the DMA 2 (31) reads image data from the DRAM, and stores the image data to the image data storage SRAM 32.

At this time, lossless compression processing needs to be independently performed for respective color components of RGB. Therefore, the image data is stored to the SRAM 32 for respective color components.

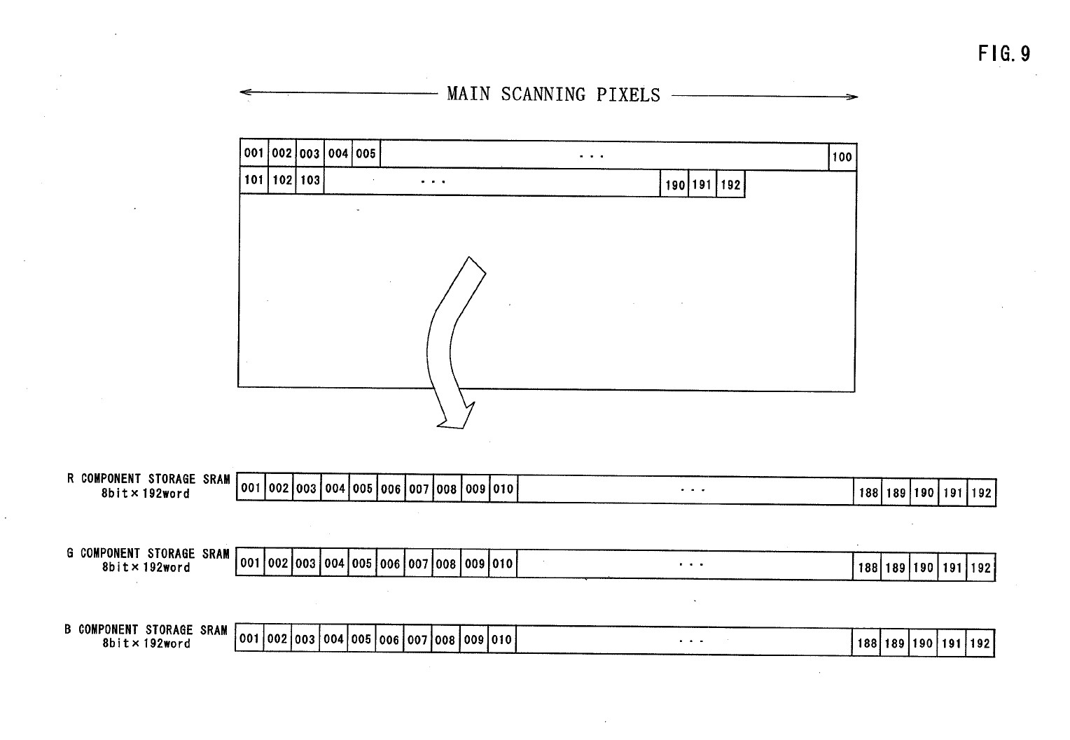

FIG. 9 is a conceptual diagram illustrating data acquisition from the DRAM to the SRAM 32.

In FIG. 9, an order in which images are obtained is different from that of the lossy compression processing of FIG. 4.

In the lossless compression, after compression processing on 100 pixels of data in the main scanning direction in a first line is finished, compression processing is subsequently performed on data having smaller address values in a second line and a third line in order.

Further, the image data read by the DMA 2 (31) is independently stored to the SRAM 32 for respective components of RGB.

Subsequently, in step S25, the DMA 2 reads the instruction data from the DRAM, and stores the instruction data to the instruction data storage SRAM 32.

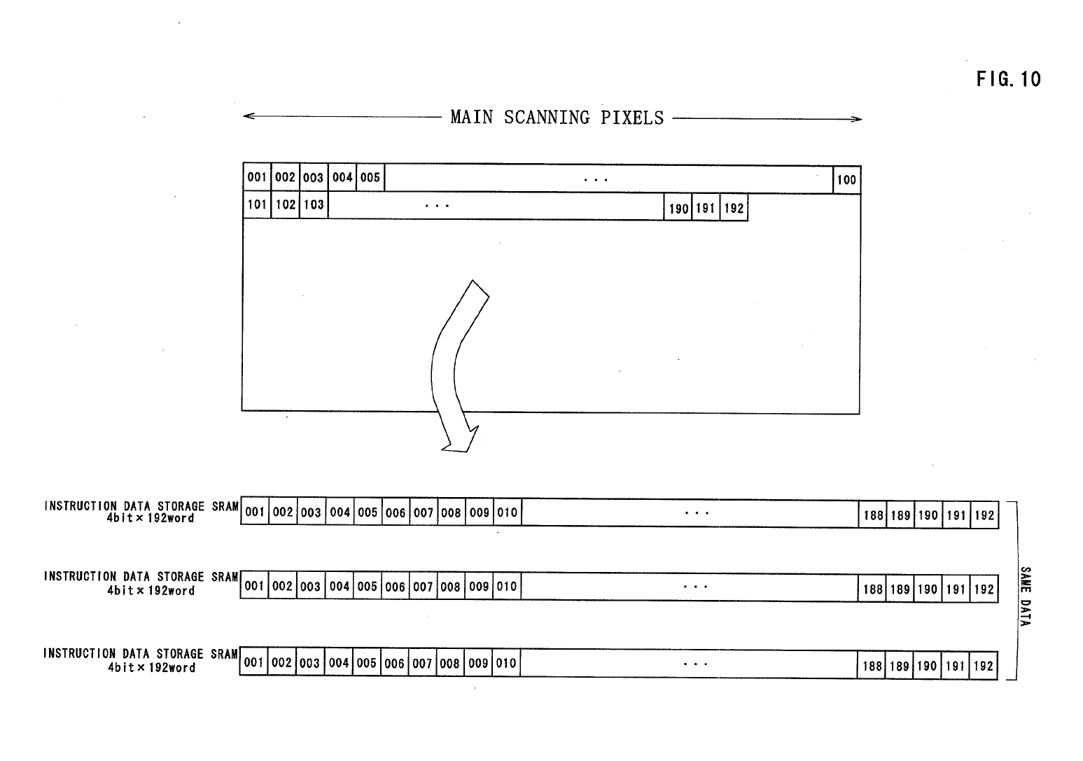

FIG. 10 is a conceptual diagram illustrating data acquisition from the DRAM to the SRAM 32.

The obtained instruction data is written to three SRAMs 32. The same data is written to the three SRAMs.

This is necessary to independently perform compression processings on respective color components of RGB. When compression processings are simultaneously performed in cooperation, one SRAM may store instruction data, and the SRAMs may be shared by respective color components.

When writing operation of image data and instruction data to the SRAM 32 is finished, a completion notification is outputted from the DMA2 module 31 to the data replacing module 33 in step S26.

In response to the completion notification, the data replacing module 33 starts replacing processing.

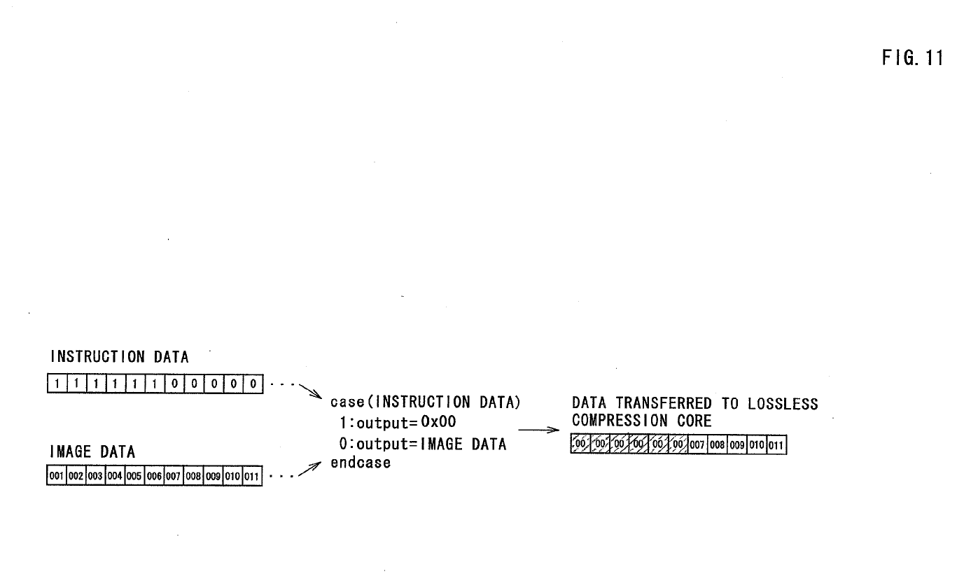

FIG. 11 is an explanatory diagram illustrating an embodiment of replacing processing.

The same operation is performed on each of the components of RGB.

First, image data “001” and corresponding instruction data “1” are respectively obtained from the SRAM 22.

Since the value “1” of the instruction data means the lossy compression processing, the image data is replaced with “0x00” and outputted to the lossless compression core 34 (R, G, B).

Subsequently, the instruction data “1” corresponding to image data “002” is read from the SRAM 32 in order, and the data processing is repeated.

In FIG. 11, when the image data “007” is processed, the instruction data value is “0”.

At this time, the instruction data value “0” means the lossless compression. Therefore, the image data is outputted to the lossless compression core 34 (R, G, B) without any processing.

When this replacing processing is repeated totally 192 times, the replaced data is transferred to the lossless compression core 34 (R, G, B) as shown in a right side of FIG. 11.

When data transfer (step S26) to the lossless compression core of FIG. 8 is finished, the compression core 34 (R, G, B) executes compression processing, and stores a result to the compressed data storage SRAM 32 in step S27.

When the compression core 34 (R, G, B) finishes the processings on 192 pixels, all the processings on the data obtained in the image data SRAM 32 are finished. Therefore, completion is notified to the DMA2 module 31.

When the DMA2 module 31 receives the completion notification from the lossless compression core 34 (R, G, B), the DMA2 module 31 performs writing operation to the DRAM according to a destination setting in step S28.

In step S29, the processings from reading to writing of data performed by the DMA 2 (31) are repeated until all pieces of the data are lossless-compressed. When the processings are finished, a finish notification is sent to the CPU 1 in step S30.

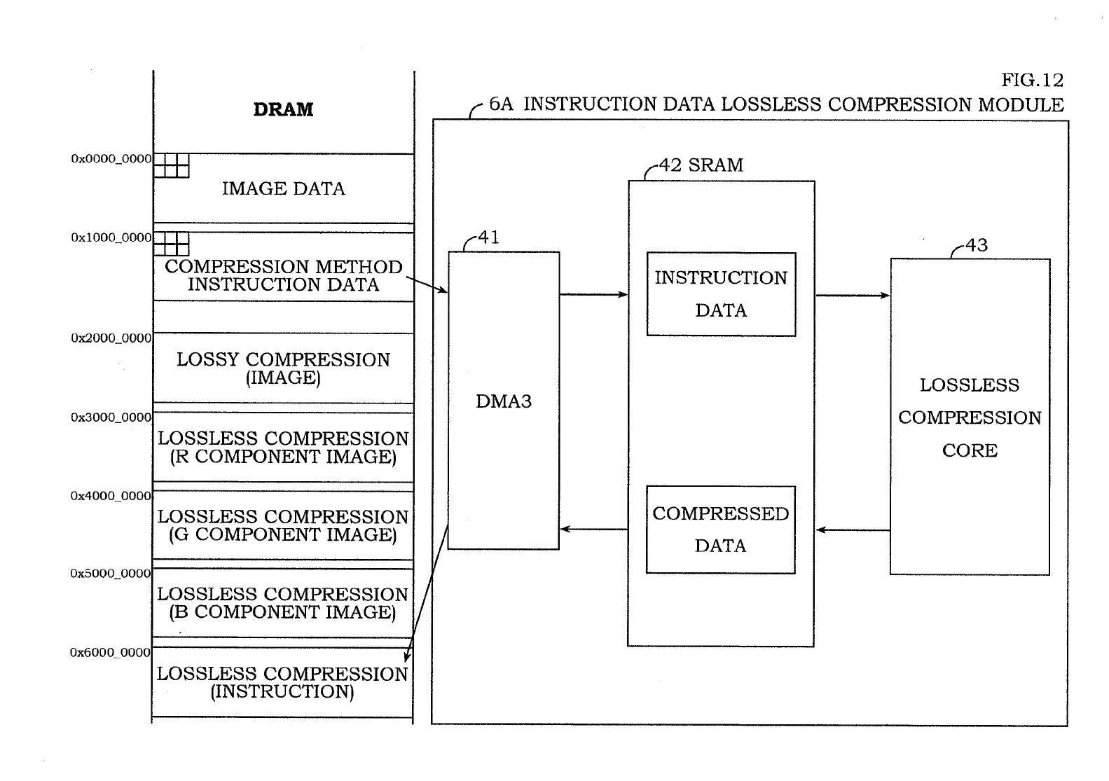

FIG. 12 is an explanatory diagram illustrating an embodiment for performing lossless-compression on instruction data.

This lossless compression processing is a processing executed by a lossless compression module 6A as shown in FIG. 1. This lossless compression processing is mainly executed by hardware including a DMA module (DMA 3) 41 for reading instruction data stored in the DRAM and writing compressed data, an SRAM 42 for buffering instruction data and compressed data, and a lossless compression core 43.

Herein, a size of the SRAM 42 for storing instruction data is 4 bits/192 words (equivalent to 192 pixels).

The SRAM 42 for storing compressed data is configured to be 64 bits/72 words.

When the lossless compression core 43 receives data, the lossless compression core 43 performs compression processing, and outputs compressed data.

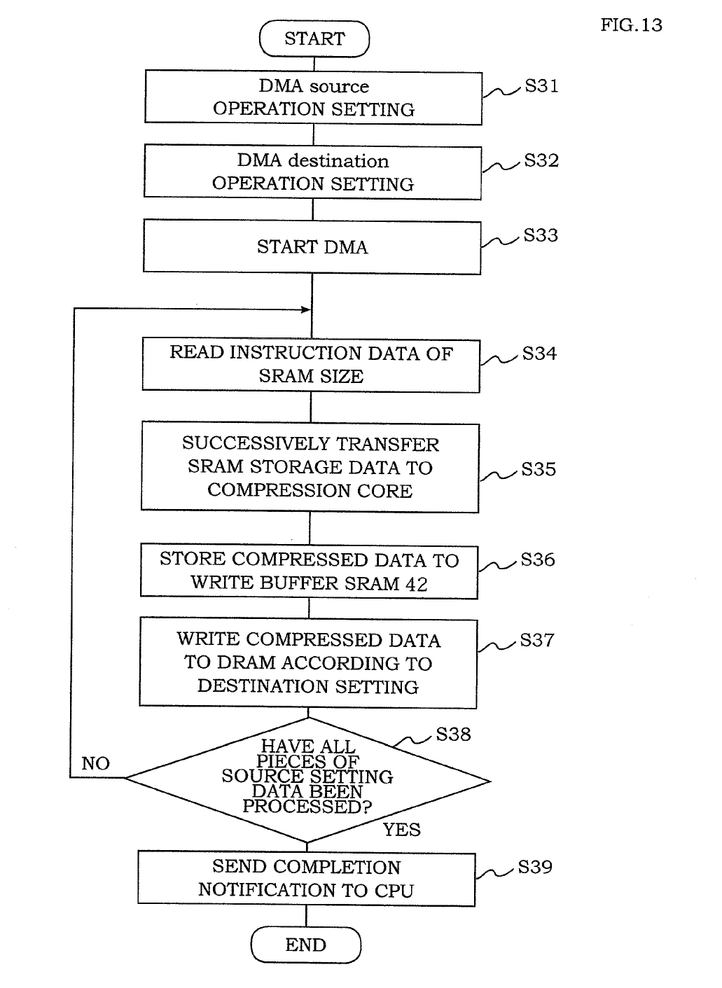

FIG. 13 is a flowchart illustrating the lossless compression processing of FIG. 12.

In order to execute the lossless compression processing of FIG. 12, first, the CPU 1 needs to perform operation settings (S31, S32).

In step S31, operation setting of a DMA source is made. Herein, a position (address) of the DRAM from which the DMA 3 (41) obtains data and a data size to be processed are set. For example, the starting address of the instruction data is set to 0x1000_{—}0000. The instruction data has a size of 100 pixels in the main scanning direction and 100 lines in the sub-scanning direction.

The above settings are completely the same as the above-described reading operation of the instruction data as shown in FIG. 8. The same instruction data is lossless-compressed.

Subsequently, operation setting of a DMA destination is performed in step S32.

Herein, a position (address) of the DRAM to which the compressed data is stored is specified.

The lossless-compressed data is specified to be stored to 0x6000_{—}0000. A size thereof is not specified, since a size of each image is different.

When the operation setting by the CPU 1 is finished, the CPU 1 starts the DMA 3 (41) in step S33.

When a DMA start instruction is given, the DMA 3 (41) starts processing for requesting data to be processed from the memory controller 3.

In step S34, first, the DMA 3 (41) reads instruction data from the DRAM, and stores the instruction data to the instruction data storage SRAM 42.

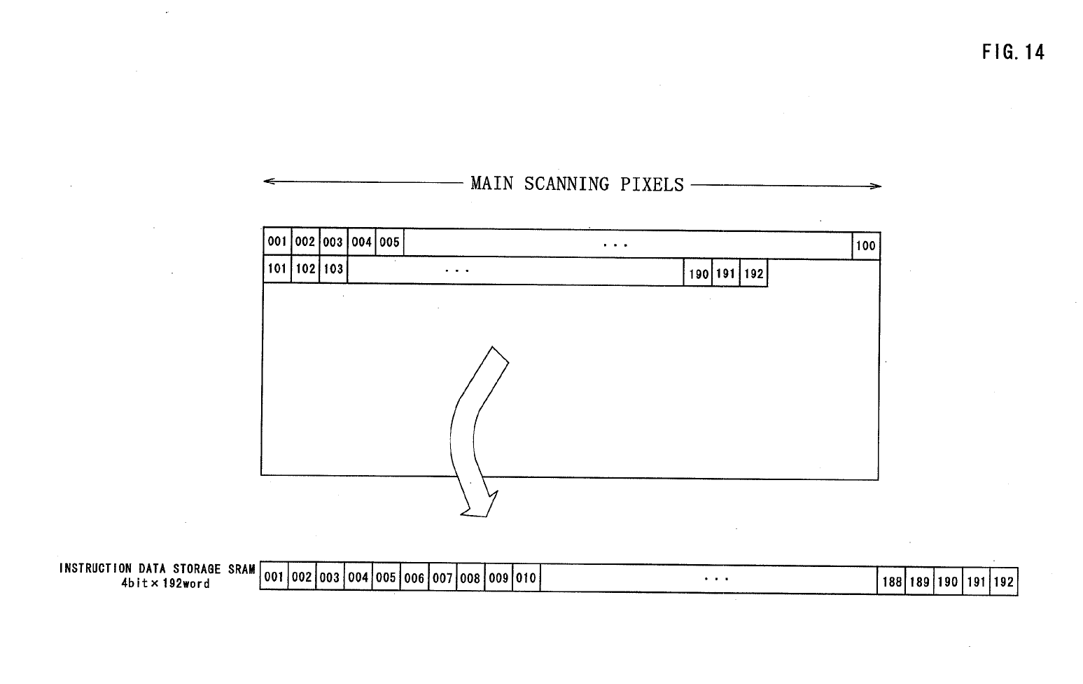

FIG. 14 is a conceptual diagram illustrating data acquisition from the DRAM to the SRAM 42.

When writing operation of instruction data to the SRAM 42 is finished, the DMA3 module 41 outputs a completion notification to the lossless compression core 43 in step S35.

The lossless compression core 43 receives the completion notification, and starts compression processing.

In step S36, a compressed result is stored to the compressed data storage SRAM 42.

When the processings on all pieces of the SRAM data are finished, completion is notified to the DMA3 module 41.

When the DMA3 module 41 receives the completion notification from the lossless compression core 43, the DMA3 module 41 performs writing operation to the DRAM according to a destination setting in step S37.

In step S38, the processings from reading to writing of data performed by the DMA 3 (41) are repeated until all pieces of the data are lossless-compressed. When the processings are finished, a finish notification is sent to the CPU 1 in step S39.

The DMAs (1, 2, 3) as shown in FIGS. 2, 7, and 12 can operate in parallel in response to a start instruction given by the CPU 1.

Therefore, the CPU 1 starts the DMAs (1, 2, 3). When processing completion notifications are received from all the DMAs, the compression processings are determined to have been finished.

When the compression processings are finished, the DRAM stores three kinds of compressed data, i.e., the lossy-compressed data and the lossless-compressed data of image data, and the lossless-compressed data of instruction data.

The above hardware configuration is divided for each function. Therefore, the system can be structured with simple configuration.

However, the image data to be compressed is read twice, and the instruction data to be compressed is read three times. Accordingly, the DRAM is accessed many times, and a very large amount of data is read and written during access.

The DRAM is accessed not only by the CPU and the DMA but also by other modules (for example, image processing module and external I/F module). Therefore, it is necessary to reduce an amount of access to the DRAM and perform image processing efficiently in a short time in order to ensure appropriate system performance.

Accordingly, the present invention suggests improvement of data access efficiency using the following hardware configuration.

<Configuration of Compression Processing Portion of Image Processing Apparatus According to the Invention>

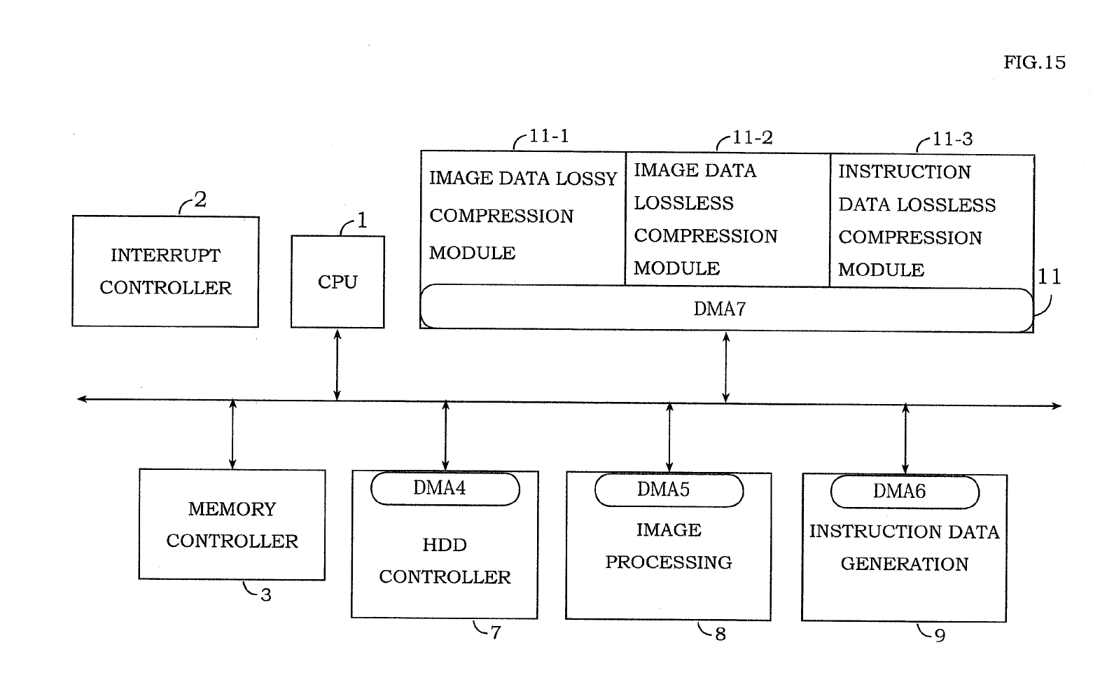

FIG. 15 is a block diagram illustrating an embodiment of functional blocks for executing compression processing in an image processing apparatus according to the present invention.

Herein, the three DMAs, i.e., the DMA 1, the DMA 2, and the DMA 3, shown in FIG. 1 are unified as one DMA 7. In other words, the DMA 7 executes functions of the three DMAs (1, 2, 3).

In a configuration of FIG. 15, processings equivalent to the conventional image compression processings as shown in FIG. 1 are achieved.

Compression processing of the image processing apparatus according to the present invention will be hereinafter described.

In FIG. 15, the CPU 1, the interrupt controller 2, the memory controller 3, the HDD controller 7, the image processing module 8, and the instruction data generation module 9 execute the same functions as those shown in FIG. 1.

A compression processing module 11 of FIG. 15 has three compression core modules (11-1, 11-2, 11-3). The compression processing module 11 reads image data and instruction data from the DRAM. Then, the compression processing module 11 causes the image data lossy compression core 11-1 to execute lossy compression on a predetermined region such as a picture in the image data, causes the image data lossless compression core 11-2 to execute lossless compression on a region including texts and the like in the same image data, and causes the instruction data lossless compression core 11-3 to execute lossless compression on the instruction data. It should be noted that the compression core 11-3 includes three cores of RGB.

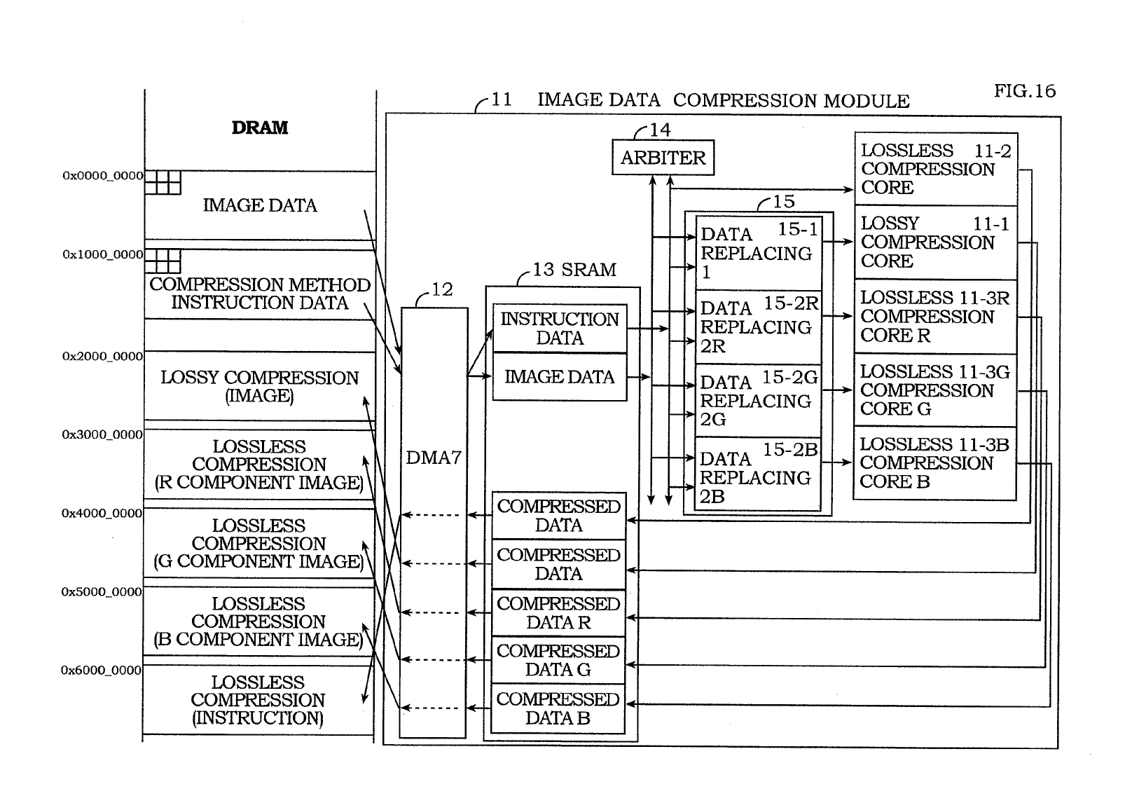

As shown in FIG. 16, the compression processing module 11 has one DMA module (DMA 7) 12. The compression processing module 11 performs data transfer equivalent to the data transfer performed by the three DMAs (1, 2, 3) as shown in FIG. 1, and performs three kinds of different data compression processings. The compression processing module 11 achieves an effect of reducing an amount of image data access to the DRAM to about half of the conventional configuration shown FIG. 1.

FIG. 16 is a block diagram illustrating functional blocks of the compression processing module 11 of FIG. 15.

Herein, the compression processing module 11 includes a DMA module (DMA 7) 12, an SRAM 13, an arbiter 14, a data replacing module 15, and compression core modules (11-1, 2, 3).

The SRAM 13 is a memory storing instruction data, image data, and totally five pieces of compressed data.

The arbiter 14 determines a module accessing the SRAM, and issues access permission to SRAM access modules such as data replacing module group and the lossless compression core 11-2.

The data replacing module 15 includes a first data replacing 1 module (15-1) generating lossy-compressed data and second data replacing 2 modules (15-2R, 2G, 2B) generating lossless-compressed data.

The first data replacing module (15-1) performs the same processing as the data replacing module 23.

The second data replacing modules (15-2R, 2G, 2B) perform the same processing as the data replacing module 33.

The lossy compression core (11-1) performs lossy compression processing on image data in which data is replaced. The lossy compression core (11-1) performs the same processing as the lossy compression core 24.

The lossless compression core (11-2) performs lossless compression processing on image data in which data is replaced. The three lossless compression cores (11-3R, 3G, 3B) perform the same processing as the lossless compression cores 34R, 34G, 34B.

As shown in FIG. 16, the DMA 7 (12) achieves the following operation. The DMA 7 (12) reads image data and instruction data from the DRAM to the SRAM. After the data replacing processing and the compression processing of each pieces of data, the lossy-compressed image data, the lossless-compressed image data, and the lossless-compressed instruction data are written to predetermined addresses of the DRAM.

<Description of Image Compression Processing According to the Invention>

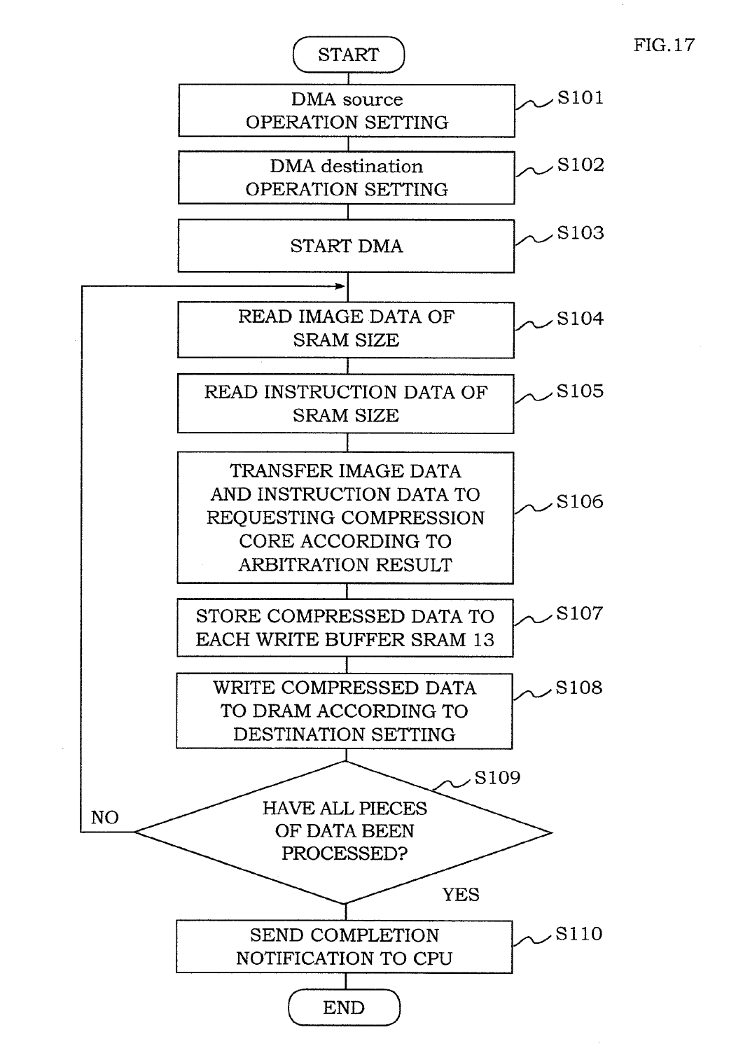

FIG. 17 is a flowchart illustrating an embodiment of image compression processing of the compression processing module 11.

In step S101, the CPU 1 sets a DMA source. In step S102, the CPU 1 sets a DMA destination.

Herein, in the source setting and the destination setting set by the CPU 1, all pieces of the data handled by the DMA 7 (12) are set. More specifically, setting is made as follows, for example.

The storage address of image data is set to an address 0x0000_{—}0000 of the DRAM. The storage address of instruction data is set to an address 0x1000_{—}0000.

Moreover, setting is made as follows. The lossy-compressed image data is stored with a starting address of 0x2000_{—}0000. The lossless-compressed image data is stored with a starting address of 0x3000_{—}0000 (R component), a starting address of 0x4000_{—}0000 (G component), and a starting address of 0x5000_{—}0000 (B component). The lossless-compressed instruction data is stored with a starting address of 0x6000_{—}0000.

When the above settings are finished, the CPU 1 starts the DMA 7 (12) in step S103.

Subsequently, in step S104, image data equivalent to a size of the SRAM is read from the DRAM.

In step S105, instruction data equivalent to the size of the SRAM is read from the DRAM.

Herein, the image data and the instruction data obtained from the DRAM 7 (12) are the same as those shown in FIGS. 4 and 5.

When data acquisition is finished, the DMA 7 notifies data acquisition completion to the lossless compression core (11-2) and the data replacing module (15-1, 15-2R, 15-2G, 15-2B).

Each module (11-2, 15-1, 15-2R, 15-2G, 15-2B) having received the notification starts writing processing of the same image data and the instruction data.

The lossy compression core performs processings in the same order as FIG. 6. In other words, the processings are performed in units of rectangular regions constituted by 8 pixels in the main scanning direction and 8 pixels in the sub-scanning direction.

However, the core (11-2) for performing lossless compression on image data performs processings in an order different from FIG. 11.

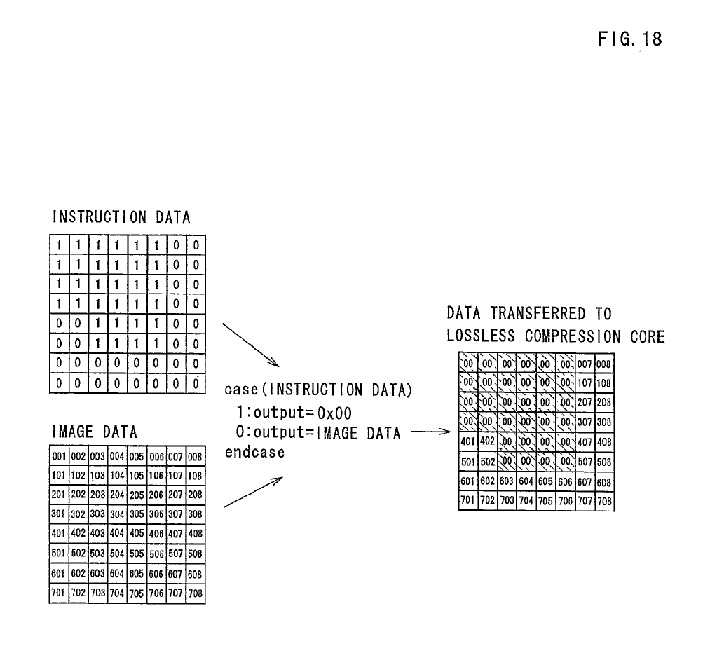

In FIG. 11, all pieces of the image data are sequentially compressed from the first line in the main scanning direction. In contrast, in a configuration of FIG. 16, compression processing is performed in the same order as lossy compression as shown in FIG. 18.

That is, a rectangular region constituted by 8 pixels in the main scanning direction and 8 pixels in the sub-scanning direction is processed line by line. More specifically, the processings are performed in an ascending order of the number of the image data.

In general, compression efficiency can be improved by processing successive image data in the lossless compression. When a rectangular region is compressed as in this configuration, the compression rate may decrease.

However, although adjacent pieces of data are less likely to be successively processed, a decrease in the compression rate would be limited, because the processing is performed in a very close region including 8×8 pixels, and neighboring images in data subjected to lossless compression have a small density change in general.

In the instruction data, a rectangular region of 8×8 pixels is lossless-compressed in a manner similar to the lossless compression processing.

In step S106, each of the lossless compression core 11-2, the first data replacing 1 module (15-1), and the second data replacing 2 module (15-2R, 2G, 2B) accesses the same instruction data storage SRAM 13 and the same image data storage SRAM 13. Therefore, the arbiter 14 of FIG. 16 arbitrates access control.

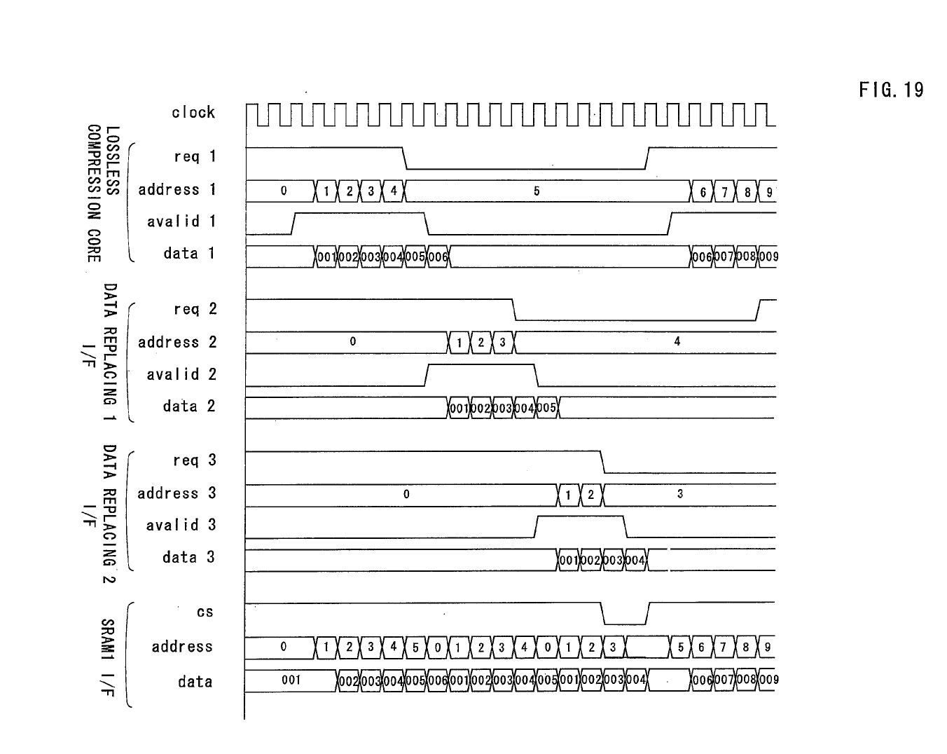

FIG. 19 is a time chart illustrating an embodiment of arbitration performed by the arbiter.

When the lossless compression core 11-2, the data replacing module (15-1), and the data replacing 2 module (15-2R, 2G, 2B) receive a data acquisition completion notification from the DMA 7 (12), all request signals (req1, req2, req3) are rendered High active in order to request data from the SRAM 13. The arbiter 14 selects one of the modules issuing requests, and activates one of address valid signals (avaid1, avalid2, avalid3).

In FIG. 19, first, the lossless compression core 11-2 is selected, and avalid1 is activated.

A module having activated (High) “avalid” and access permission to the SRAM 13 can obtain data corresponding to an address outputted in a subsequent clock.

The SRAM I/F side receives a module selection signal from the arbiter 14, and outputs a request signal inputted from each module (11-2, 15-1, 15-2R, 15-2G, 15-2B) to an SRAM chip select signal (CS).

An address signal is also selected from each module (11-2, 15-1, 15-2R, 15-2G, 15-2B), and is outputted to the SRAM 13 as the address signal.

In step S107, data is stored to the SRAM 13.

In the above configuration, time division access from a plurality of modules to the same SRAM 13 is achieved.

However, if three read ports can be prepared in the SRAM, it is not necessary to perform time division control.

When each compression core (11-1, 11-2, 11-3R, G, B) finishes processings, a completion notification is given to the DMA 7 (12).

In step S108, the DMA 7 (12) performs writing processing of compressed data stored in the SRAM 13 to the DRAM in an order of reception of a completion notification.

After writing to the DRAM is completed, the DMA 7 (12) repeats reading and writing until processings of all pieces of the data are finished in step S109. After all pieces of the data are processed, a finish notification is given to the CPU 1 in step S110.

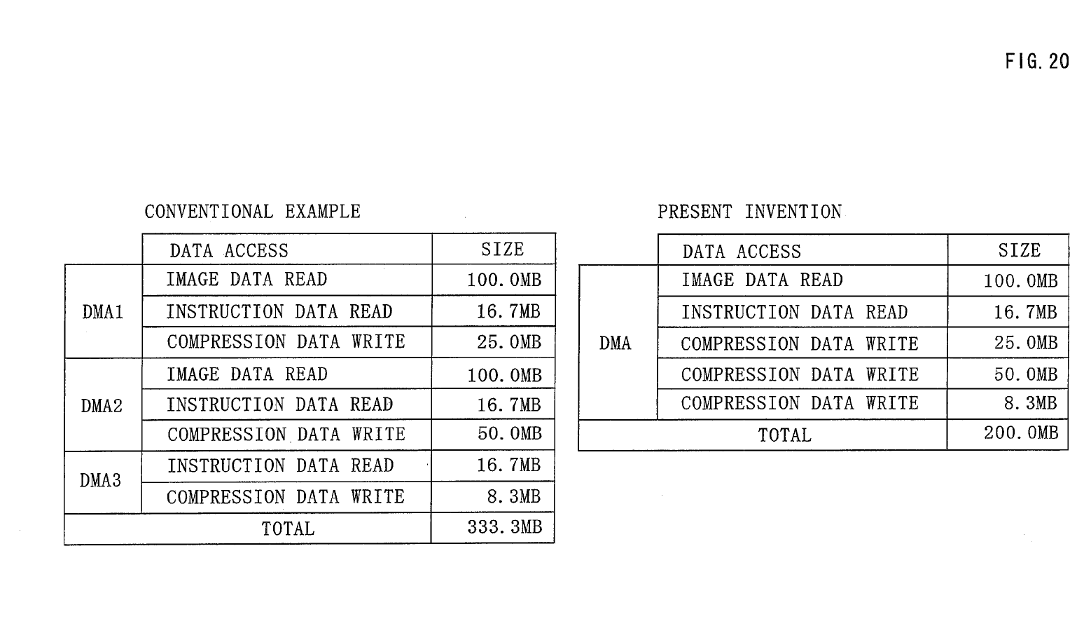

When the above-described module configuration as shown in FIG. 16 is used, an amount of data access (200 MB) to the DRAM during data compression is about 133.3 MB less, as shown in FIG. 20, than an amount of access (333.3 MB) in the conventional example as in FIG. 1. Therefore, the amount of access can be reduced by 40%.

Herein, calculation is performed on an assumption that the lossless compression has a compression rate of 50% and the lossy compression has a compression rate of 25%.

A circuit configuration of the arbiter and the DMA according to the present invention has about 300 thousand gates. Accordingly, a magnitude of the circuit can be reduced by about 300 thousand gates, compared with a conventional circuit configuration including three DMAs (200 thousand gates×3) as shown in FIG. 1.

<Configuration of Conventional Decompression Processing>

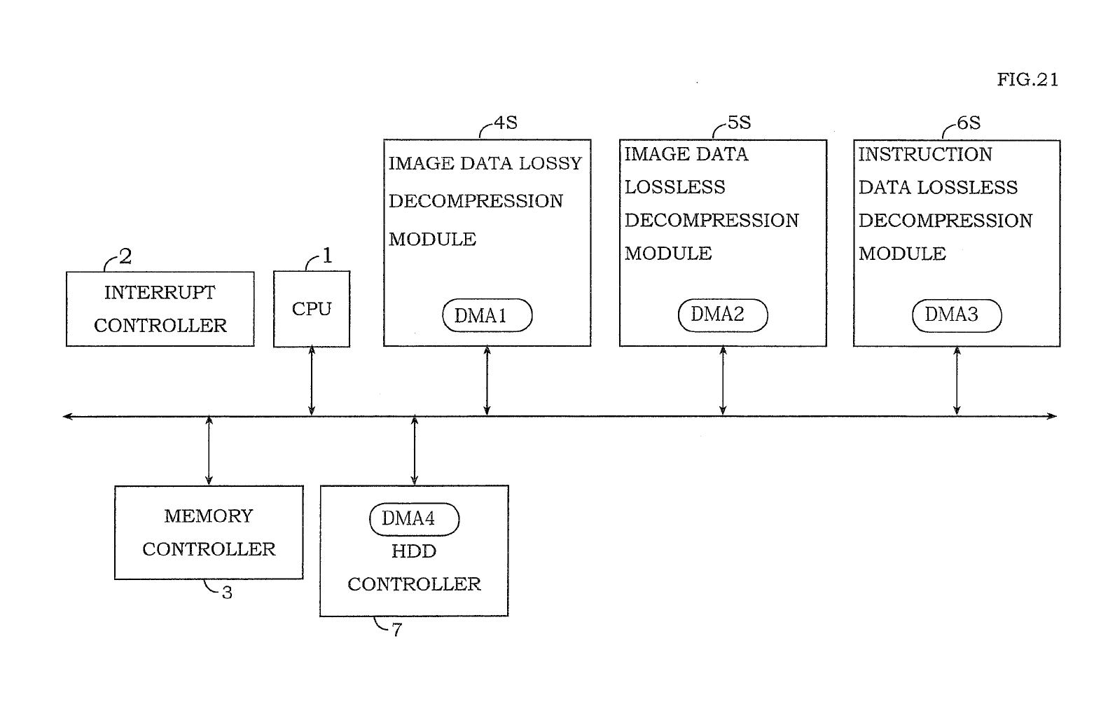

FIG. 21 is a block diagram illustrating a conventional configuration for performing decompression processing.

The image data and the instruction data subjected to the lossless compression and the lossy compression for each rectangular region are decompressed by a hardware configuration as shown in FIG. 21 to be returned back to original image data.

In FIG. 21, three decompression processing modules (4S, 5S, 6S) are arranged in a manner similar to the compression modules of FIG. 1.

More specifically, the lossless decompression module 4S for decompressing instruction data, the lossless decompression module 5S for decompressing lossless-compressed image data, and lossy decompression module 6S for decompressing lossy-compressed image data are arranged.

These decompression processing modules (4S, 5S, 6S) have respectively independent DMAs (1, 2, 3) to read and write data from a DRAM memory.

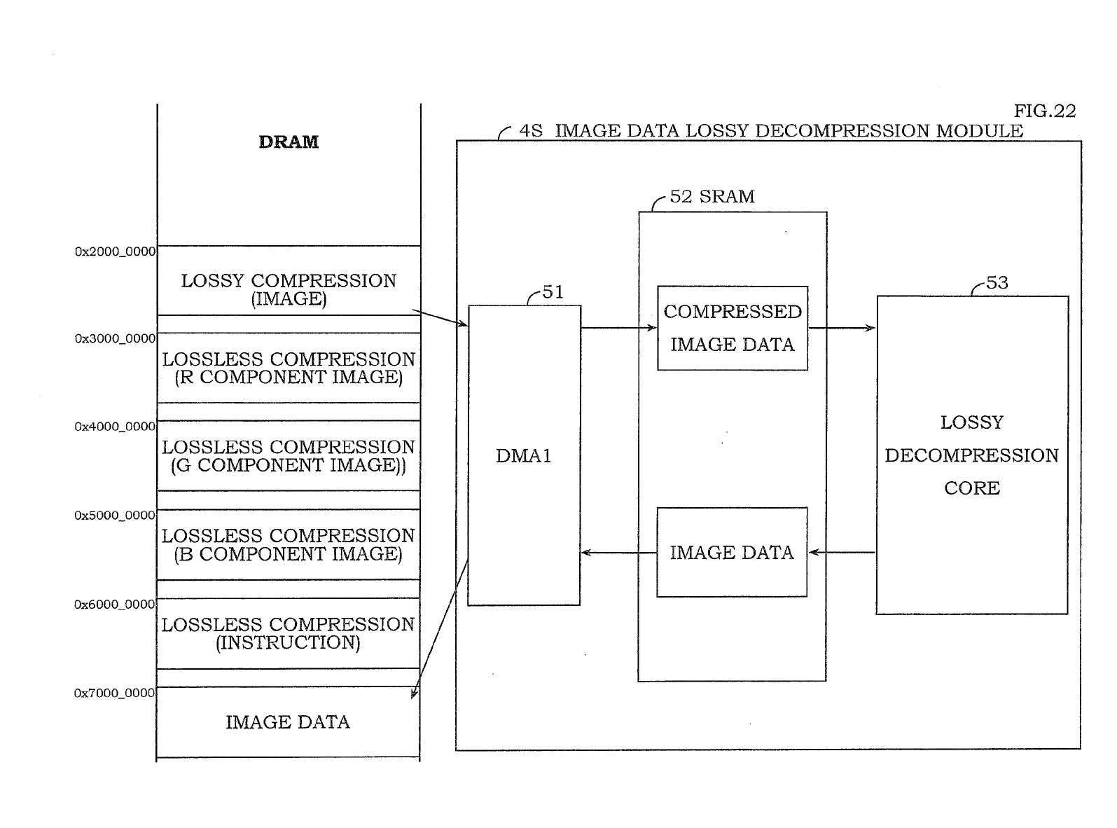

FIG. 22 is an explanatory diagram illustrating configuration blocks for performing lossy decompression processing on image data.

This lossy decompression processing is a processing executed by an image data lossy compression module 4S as shown in FIG. 21. This lossy decompression processing is mainly executed by hardware including a DMA module (DMA 1) 51 for reading lossy-compressed image data stored in the DRAM and writing image data, an SRAM 52 for buffering compressed data and image data, and a lossy decompression core 53.

Herein, the SRAM 52 for storing compressed data has 64 bits/72 words. A size for storing image data is 24 bits/192 words (equivalent to 192 pixels).

When the lossy decompression core 53 receives compressed data, the lossy decompression core 53 performs decompression processing, and outputs image data.

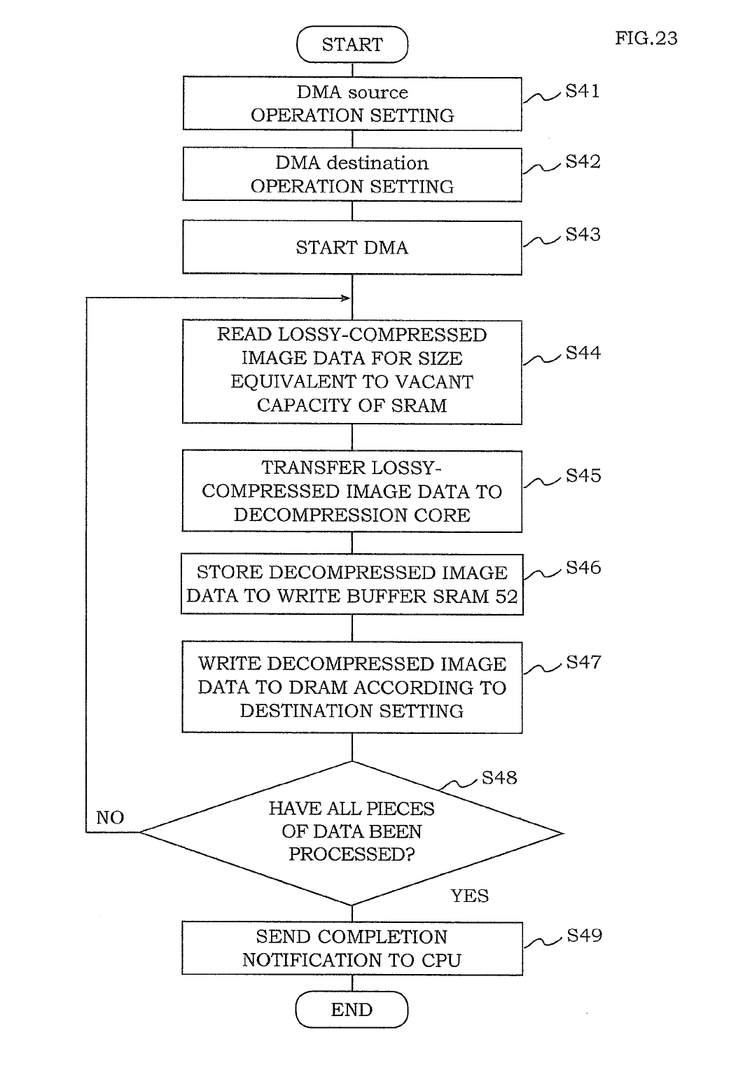

FIG. 23 is a flowchart illustrating lossy decompression processing as shown in FIG. 22.

In order to execute the lossy decompression processing of FIG. 22, first, the CPU 1 needs to perform operation setting.

In step S41, operation setting of a DMA source is made.

Herein, a position (address) of the DRAM from which the DMA 1 (51) obtains data and a data size to be processed are set. For example, this setting is automatically made by the CPU 1 based on a size of an original document and a state of use of the main memory.

For example, the address of the lossy-compressed data is set to 0x2000_{—}0000.

Subsequently, operation setting of a DMA destination is performed in step S42.

Herein, a position (address) of the DRAM to which the decompressed image data is stored is specified.

The lossy-decompressed image data is specified to be stored to 0x7000_{—}0000. A size thereof is specified as 100 pixels in the main scanning direction and 100 lines in the sub-scanning direction based on a value of the image data prior to compression.

When the operation setting by the CPU 1 is finished, the CPU 1 starts the DMA 1 (51) in step S43.

When a DMA start instruction is given, the DMA 1 (51) starts processing for requesting data to be processed from the memory controller 3.

In step S44, first, the DMA 1 (51) reads lossy-compressed data from the DRAM and stores the lossy-compressed data to the compressed data storage SRAM 52.

When the writing processing of the lossy-compressed data to the SRAM 52 is finished, a finish notification is outputted from the DMA 1 module 51 to the lossy decompression core 53 in step S45.

When the lossy decompression core 53 receives the completion notification, the lossy decompression core 53 starts decompression processing.

In step S46, the decompression core 53 executes decompression processing, and a result is stored to the image data storage SRAM 52. When the writing processing to the SRAM is finished, completion is notified to the DMA 1 module 51.

When the DMA 1 module 51 receives the completion notification from the lossy decompression core 53, the decompressed image data is written to the DRAM according to the destination setting in step S47.

In step S48, the processings from reading to writing of data performed by the DMA 1 (51) are repeated until all pieces of the data are lossy-decompressed. When the processings are finished, a finish notification is sent to the CPU 1 in step S49.

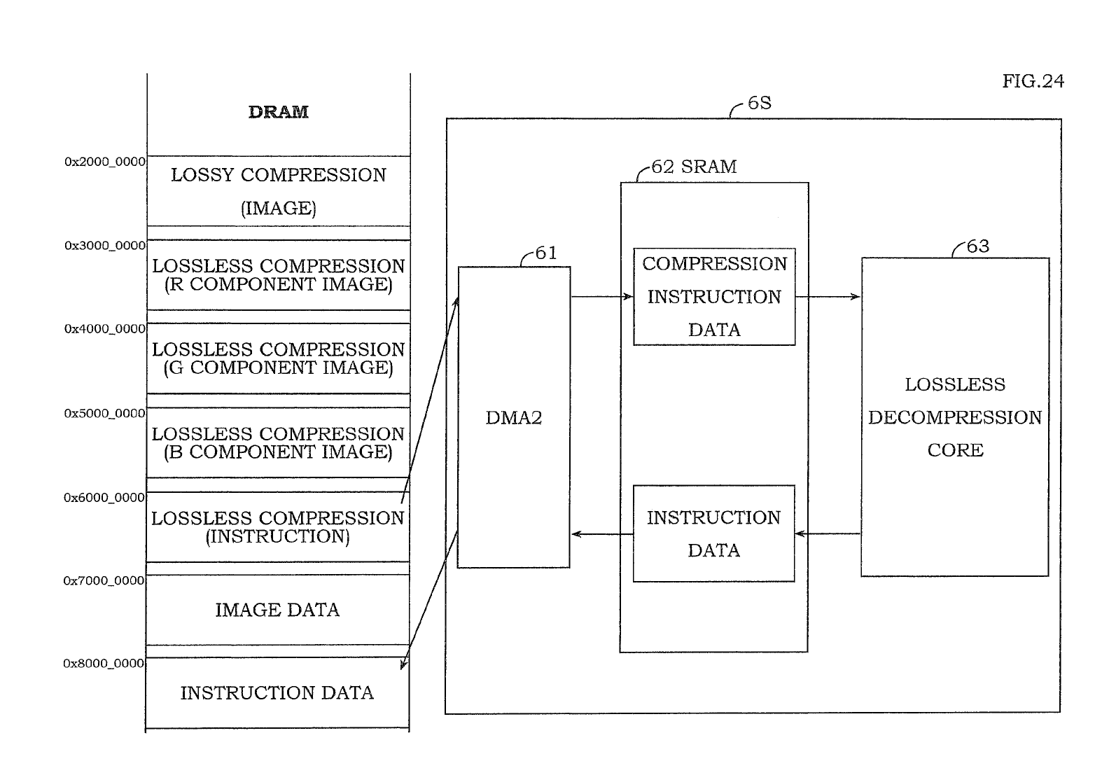

FIG. 24 is an explanatory diagram illustrating an embodiment for performing lossless decompression processing on instruction data.

This lossless decompression processing is a processing executed by an instruction data lossless decompression module 6S as shown in FIG. 21. This lossless decompression processing is mainly executed by hardware including a DMA module (DMA 2) 61 for reading lossless-compressed instruction data stored in the DRAM and writing decompressed instruction data, an SRAM 62 for buffering compressed data and decompressed instruction data, and a lossless decompression core 63.

Herein, the SRAM 62 for storing compressed data has 64 bits/72 words. A size of the SRAM 62 for storing instruction data is 4 bits/192 words (equivalent to 192 pixels).

When the lossless decompression core 63 receives data, the lossless decompression core 63 performs decompression processing, and outputs decompressed instruction data.

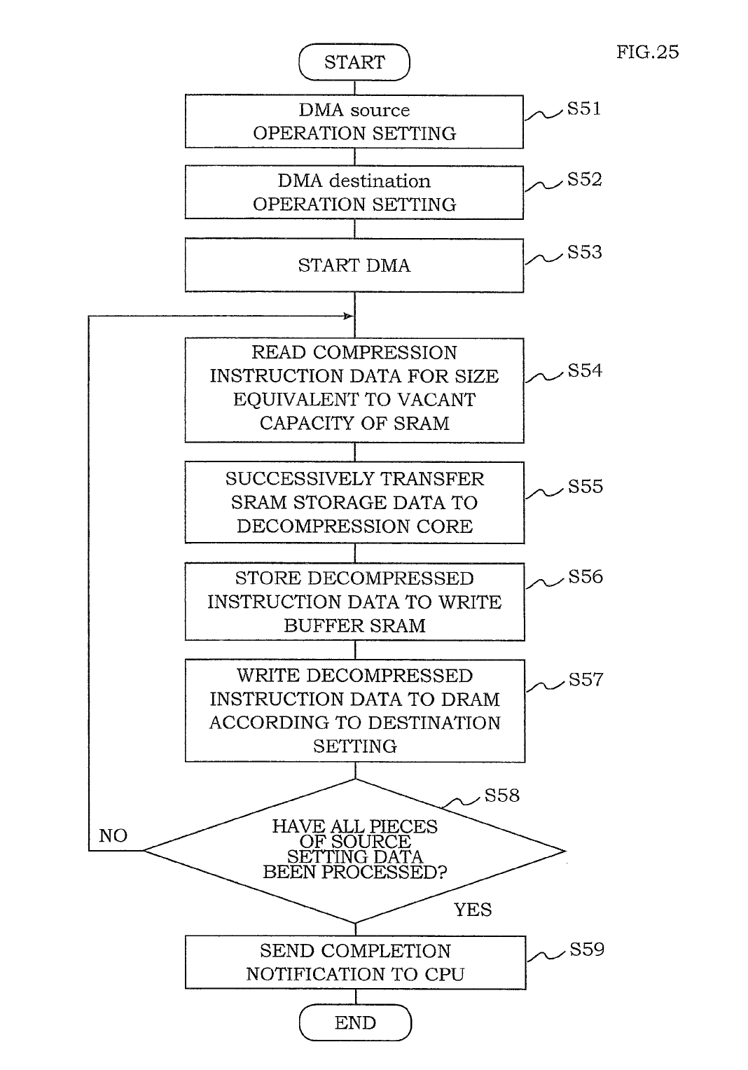

FIG. 25 is a flowchart illustrating the lossless decompression processing of FIG. 24.

In order to execute the lossless decompression processing of FIG. 24, the CPU 1 needs to perform operation setting.

In step S51, operation setting of a DMA source is made. Herein, a position (address) of the DRAM from which the DMA 2 (61) obtains data and a data size to be processed are set.

For example, a starting address of the compression instruction data is set to 0x6000_{—}0000, and a size thereof is set to 8.3 MB.

Subsequently, operation setting of a DMA destination is performed in step S52.

Herein, a position (address) of the DRAM to which the decompressed instruction data is stored is specified.

The lossless-decompressed data is specified to be stored to 0x8000_{—}0000. A size thereof is specified as 100 pixels in the main scanning direction and 100 lines in the sub-scanning direction.

When the operation setting by the CPU 1 is finished, the CPU 1 starts the DMA 2 (61) in step S53.

When a DMA start instruction is given, the DMA 2 (61) starts processing for requesting data to be processed from the memory controller 3.

In step S54, first, the DMA 2 (61) reads compression instruction data from the DRAM and stores the compression instruction data to the compression instruction data storage SRAM 62.

When the writing processing of the compression instruction data to the SRAM 62 is finished, a completion notification is outputted from the DMA 3 module 61 to the lossless decompression core 63 in step S55

When the lossless decompression core 63 receives the completion notification, the lossless decompression core 63 starts decompression processing.

In step S56, a decompressed result is stored to the decompressed data storage SRAM 62.

When the processings on all pieces of the SRAM data are finished, completion is notified to the DMA 2 module 61.

When the DMA 2 module 61 receives the completion notification from the lossless decompression core 63, writing processing to the DRAM is performed according to the destination setting in step S57.

In step S58, the processings from reading to writing of data performed by the DMA 2 (61) are repeated until all pieces of the data are lossless-decompressed. When the processings are finished, a finish notification is sent to the CPU 1 in step S59.

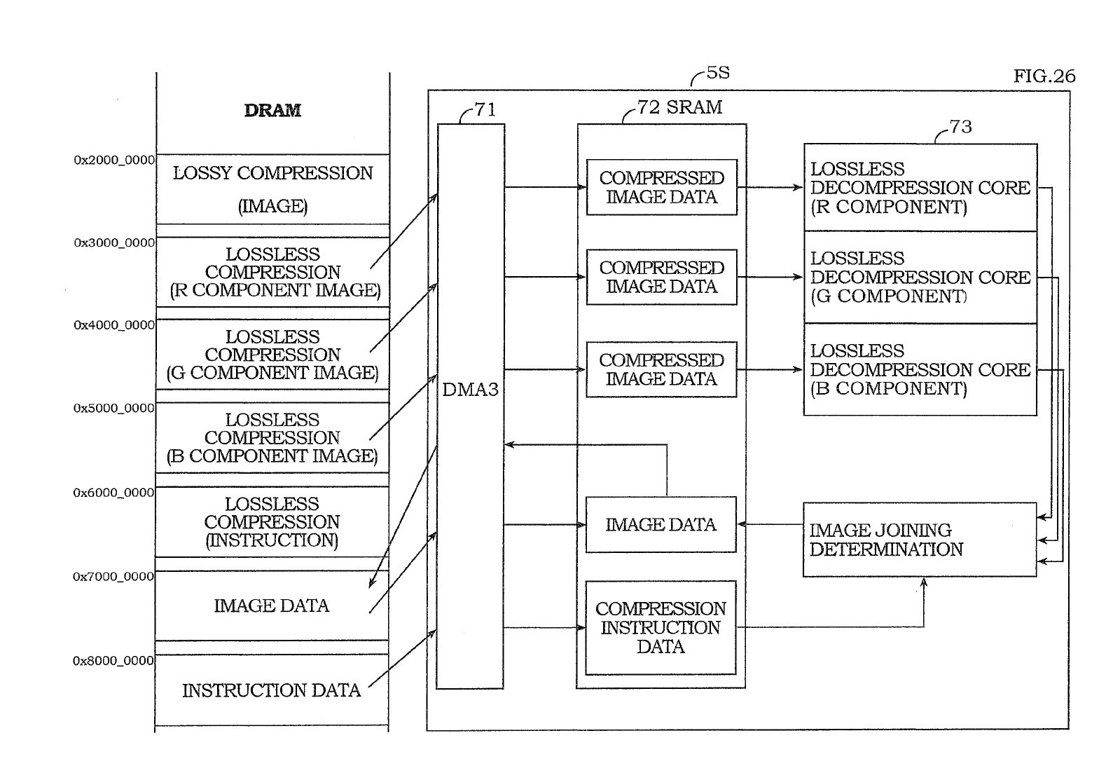

FIG. 26 is an explanatory diagram for performing lossless decompression processing on lossless-compressed image data.

This lossless decompression processing is a processing executed by a lossless decompression module 5S of FIG. 21.

A lossless decompression core 73 for performing lossless decompression independently for respective color components of RGB has three decompression cores. Accordingly, a configuration of the SRAM 72 has three sets of 8 bits/192 words. Further, it is necessary to join the image data generated by an apparatus of FIG. 24. Therefore, there is the SRAM storing lossy-compressed image data and instruction data, and the instruction data is used to generate final image data from lossless-decompressed image data and lossy-decompressed image data.

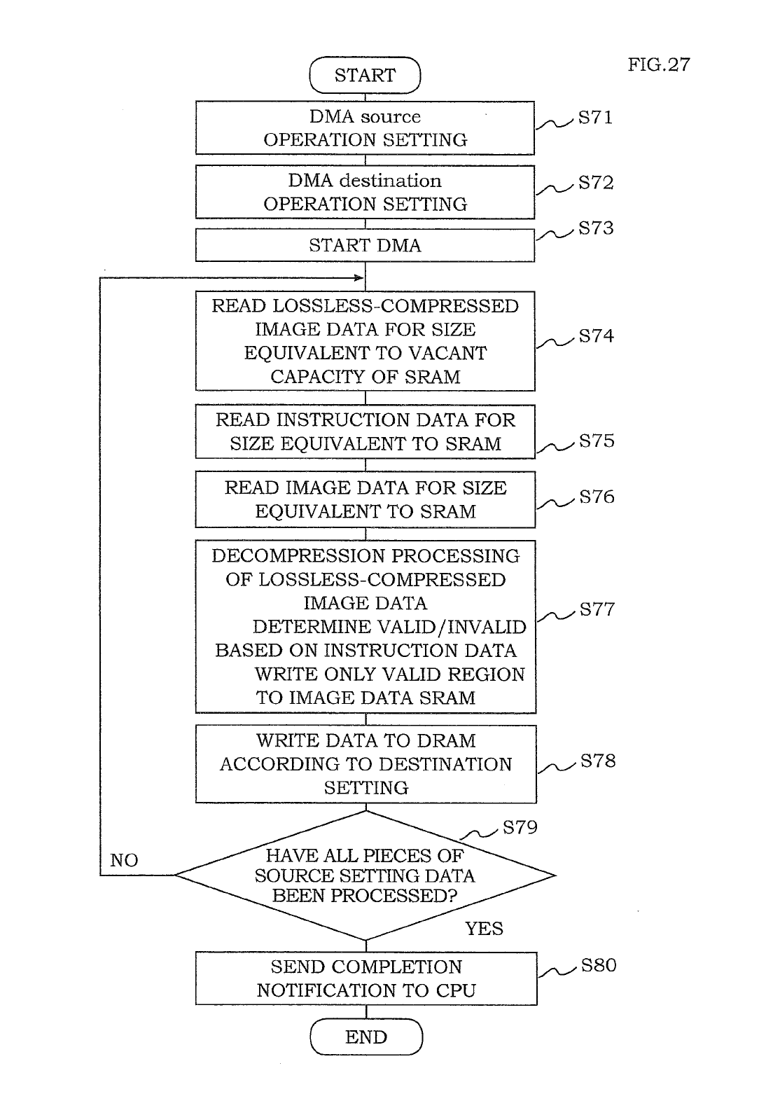

FIG. 27 is a flowchart illustrating lossless decompression processing of FIG. 26.

In order to execute the lossless decompression processing of FIG. 26, the CPU 1 needs to perform operation setting.

In step S71, operation setting of a DMA source is made. Herein, positions (addresses) of the DRAM from which compressed data and instruction data are read are specified.

An R region of the lossless-compressed data is specified to be stored to 0x3000_{—}0000. A G region thereof is specified to be stored to 0x4000_{—}0000. A B region thereof is specified to be stored to 0x5000_{—}0000. A size of each of the R, G, B regions is set to 50 MB. Setting is made as follows. The image data is read from 0x7000_{—}0000. The instruction data is read from 0x8000_{—}0000.

Subsequently, operation setting of a DMA destination is performed in step S72.

Herein, the starting address of the image data is set to 0x7000_{—}0000, and the image data has 100 pixels in the main scanning direction and 100 lines in the sub-scanning direction. In other words, in this setting, the image data read by the DMA 3 is written back to the same position after the image processing.

When the operation setting by the CPU 1 is finished, the CPU 1 starts the DMA 3 (71) in step S73.

When a DMA start instruction is given, the DMA 3 (71) starts processing for requesting data to be processed from the memory controller 3.

In step S74, the DMA 3 (71) reads the lossless-compressed data from the DRAM, and stores the lossless-compressed data to the compressed data storage SRAM 72.

At this time, it is necessary to independently perform lossless decompression processing for each of color components of RGB. Therefore, the lossless-compressed data is stored to the SRAM 72 for each of the color components.

Subsequently, in step S75, the DMA 3 reads the instruction data from the DRAM, and stores the instruction data to the instruction data storage SRAM 72.

The obtained instruction data is written to the SRAM 72.

When the writing processing of the image data and the instruction data to the SRAM 72 is finished, a completion notification is outputted from the DMA 3 module 31 to the lossless decompression core 73 in step S76.

In response to the completion notification, the lossless decompression core 73 starts decompression processing.

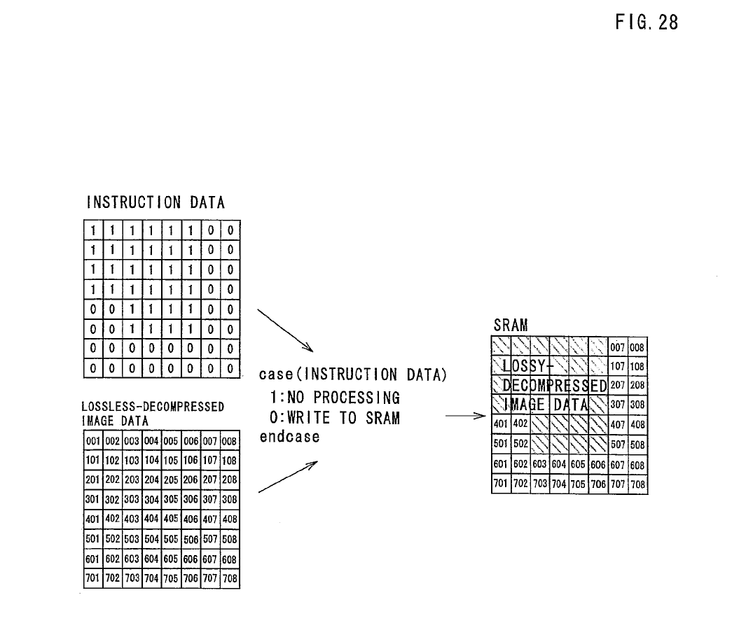

FIG. 28 is an explanatory diagram illustrating an embodiment of image data generation.

The same operation is performed on each of the components of RGB.

First, instruction data “1” corresponding to image data “001” is respectively obtained from the SRAM 72.

Since the value “1” of the instruction data means that lossy-decompressed image data is used as a valid image, the lossless-decompressed image data is not written to the SRAM.

Subsequently, the instruction data “1” corresponding to image data “002” is read from the SRAM 32 in order, and the data processing is repeated.

In FIG. 28, when image data “007” is processed, the instruction data value is “0”.

At this time, the instruction data value “0” means that a lossless-decompressed image is used as a valid image. Therefore, the lossless decompressed image data is written to the SRAM.

When this replacing processing is repeated totally 192 times, image data joined based on both of lossless and lossy decompressed image data are obtained as shown in a right part of FIG. 28.

When the decompression core (R, G, B) completes processing on 192 pixels, and writing processing to the SRAM is finished, completion is notified to the DMA 3 module 61 in step S77.

When the DMA 3 module 61 receives the completion notification from a lossless decompression core 64 (R, G, B), the DMA 3 module 61 performs writing processing to the DRAM according to a destination setting in step S78.

In step S79, the processings from reading to writing of data performed by the DMA 3 (61) are repeated until image data processings are performed on all pieces of the data. When the processings are finished, a finish notification is sent to the CPU 1 in step S80.

The DMAs (1, 2) as shown in FIGS. 22 and 24 can operate in parallel in response to a start instruction given by the CPU 1.

Therefore, the CPU 1 starts the DMAs (1, 2). When processing completion notifications are received from all the DMAs, the DMA 3 of FIG. 26 is started. When the completion notification is received, ultimate image data is obtained.

In the above-described decompression method according to the conventional technique, it is necessary to place the image data and the instruction data serving as intermediate data to the DRAM. Therefore, the amount of data for memory access to the DRAM is large.

<Configuration of Decompression Processing According to the Invention>

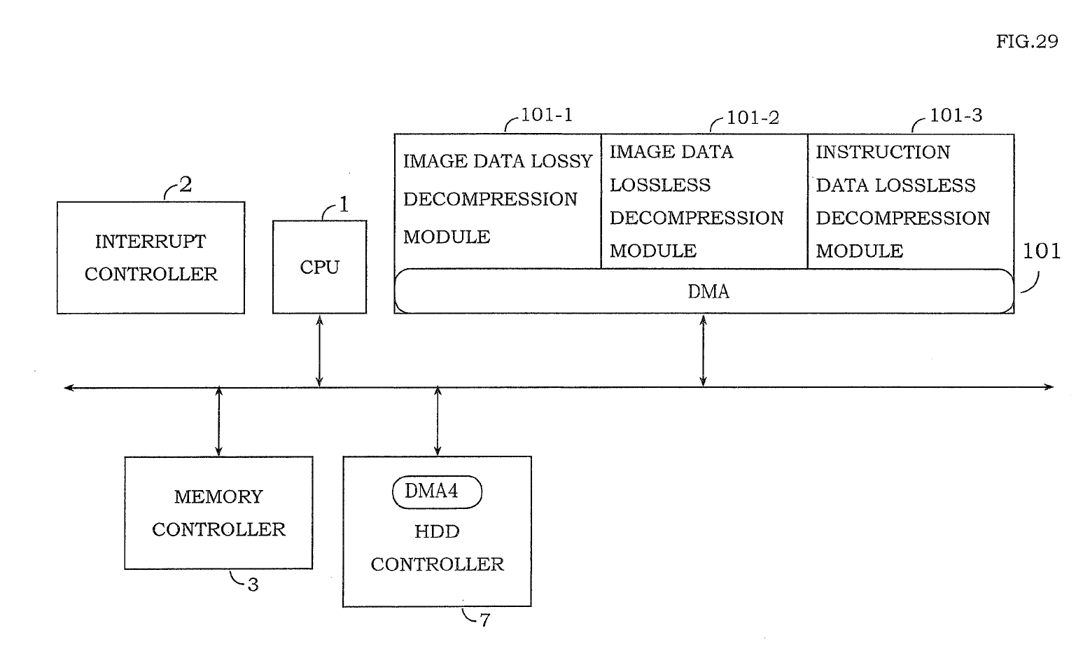

FIG. 29 is a block diagram illustrating an embodiment of functional blocks for executing decompression processing according to the present invention.

Unlike the conventional example of FIG. 21, three decompression modules (4S, 5S, 6S) do not have independent DMAs but share one DMA 111.

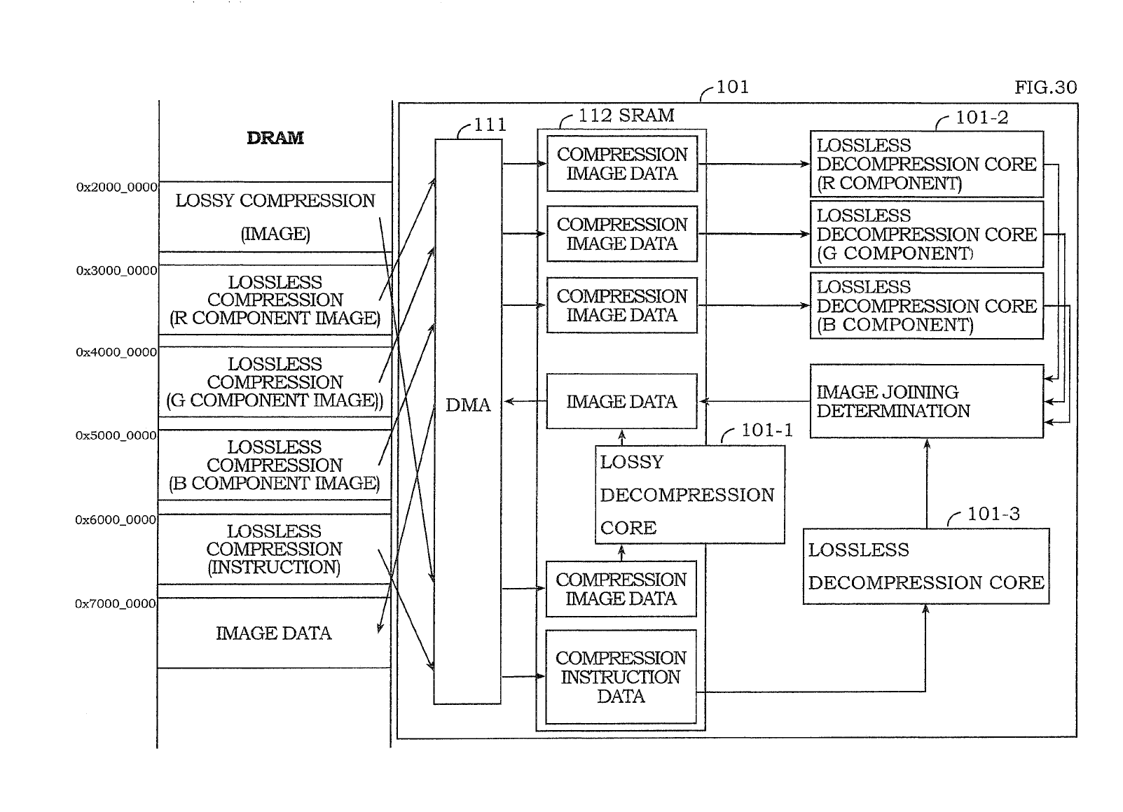

FIG. 30 is a block diagram illustrating functional blocks of a decompression processing module 101 according to the present invention.

As shown in FIG. 30, compressed data is respectively decompressed by the decompression cores (101-1, 101-2, 101-3).

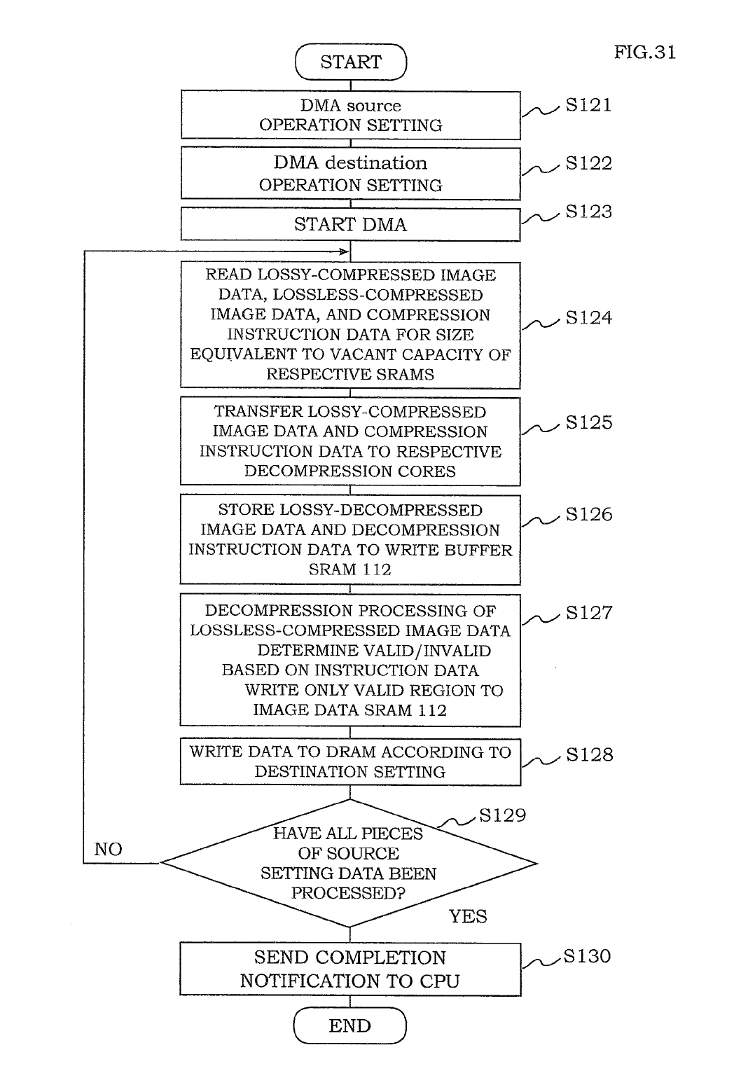

FIG. 31 is a flowchart illustrating decompression processing according to the present invention.

First, the CPU needs to perform operation setting. In step S121, operation setting of a DMA source is performed.

Herein, a position (address) of the DRAM from which the DMA obtains data and a data size to be processed are set. For example, this setting is automatically made by the CPU based on a size of an original document and a state of use of the main memory.

For example, the lossy-compressed data is stored at an address of 0x2000_{—}0000. The lossless-compressed R component image is stored at an address of 0x3000_{—}0000. The lossless-compressed G component image is stored at an address of 0x4000_{—}0000. The lossless-compressed B component image is stored at an address of 0x5000_{—}0000. The lossless-compressed instruction data is stored at an address of 0x6000_{—}0000.

Subsequently, in step S122, operation setting of a DMA destination is performed.

Herein, a position (address) of the DRAM to which the processed image data is stored is specified.

The processed image data is specified to be stored to 0x7000_{—}0000. A size thereof is specified as 100 pixels in the main scanning direction and 100 lines in the sub-scanning direction based on a value of the image data prior to compression.

When the operation setting by the CPU is finished, the CPU starts the DMA in step S123.

When a DMA start instruction is given, the DMA starts processing for requesting data to be processed from the memory controller 3.

In step S124, the DMA reads the lossy-compressed data, the lossless-compressed image data, and the compression instruction data from the DRAM, and stores the read data to each SRAM.

When the writing processing of the lossy-compressed image data and the compression instruction data to the SRAM is finished, a completion notification is outputted from the DMA module to each decompression core in step S125.

When the lossy decompression core for decompressing image data and the lossless decompression core for decompressing instruction data receive the completion notification, decompression processing is started.

In step S126, the image data of the decompressed data is transferred to a write buffer SRAM, and the instruction data thereof is transferred to an image joining block.

Subsequently, in S127, lossless decompression is performed. The decompressed image data is transferred to the image joining block, and validity/invalidity is determined for each pixel. At this time, instruction data previously stored in the image joining block is used, and instruction data corresponding to the image data is used to make determination. When a pixel is determined to be a valid pixel, the write buffer is overwritten. When a pixel is determined to be an invalid pixel, no processing is performed, and a subsequent pixel is determined.

When all pieces of the image data stored in the image data storage SRAM have been processed, the DMA 111 writes the image data to the memory (S128).

In step S129, the processings from reading to writing of data performed by the DMA are repeated until image data processings are performed on all pieces of the data. When the processings are finished, a finish notification is sent to the CPU 1 in step S130.

As described above, a reason why the DMA 111 can simultaneously execute the respective decompression processings in parallel is because compression processing is performed for each rectangular data regardless of the compression method.

As described above, in the decompression processing using the configurations of FIG. 29 and FIG. 30, the amount of access to the DRAM can be reduced by about 40%, compared with a case where decompression processing is performed according to the configuration of the conventional technique as shown in FIG. 21 to FIG. 28.

Further, in the circuit configuration of the decompression processing, the circuit configuration of the DMA has about 300 thousand gates. Accordingly, the magnitude of the circuit can be reduced by about 300 thousand gates, compared with the conventional circuit configuration as shown in FIG. 21 and the like.

1. An image processing apparatus comprising:
a storage unit for storing uncompressed data;
a compression processing unit for performing lossless compression and lossy compression on the uncompressed data;
a memory controller for reading the uncompressed data from the storage unit and writing compressed data compressed by the compression processing unit; and
a control unit for controlling transfer of the uncompressed data stored in the storage unit to the compression processing unit, wherein
the compression processing unit has one DMA and simultaneously executes the lossless compression and the lossy compression, and wherein
with respect to a rectangular region constituted by a predetermined number of pixels in a main scanning line direction and a predetermined number of pixels in a sub-scanning line direction, the control unit uses the DMA to successively transfer the uncompressed data by the rectangular region in such a manner that transferring the uncompressed data on one main scanning line in the rectangular region is followed by shifting in the sub-scanning line direction to transfer the uncompressed data on the next main scanning line in the rectangular regions, and controls the compression processing unit successively performs the compression processing of data for each rectangular region.

2. The image processing apparatus according to claim 1,
wherein the uncompressed data, which is to be compressed, stored in the storage unit, includes image data and instruction data associated with each pixel of the image data and indicating which of the lossless compression or the lossy compression is to be executed, and
the DMA transfers the image data and the instruction data from the storage unit to the compression processing unit for each rectangular region, and the compression processing unit performs lossless compression on the transferred instruction data and performs the lossless compression or the lossy compression on the transferred image data based on the corresponding instruction data.

3. The image processing apparatus according to claim 2, wherein the compression processing unit further comprises an access arbitrating unit, and the access arbitrating unit performs, in a time-division manner, replacement processing for distinguishing image data that the DMA obtains from the storage unit so that image data to be lossless-compressed and image data to be lossy-compressed are distinguished and compressed.

4. The image processing apparatus according to claim 3, wherein the compression processing unit comprises a first compression core for performing the lossless compression on the instruction data, a second compression core for performing the lossy compression on the image data to be lossy-compressed, and a third compression core for performing the lossless compression on the image data to be lossless-compressed, and wherein
each compression core executes the compression processing on the instruction data or the image data for each rectangular region respectively given.

5. The image processing apparatus according to claim 1 further comprising a decompression processing unit for performing lossless decompression and lossy decompression on compressed data, wherein
the decompression processing unit includes one DMA, a first lossless decompression core for performing lossless decompression processing on instruction data in the compressed data, a second lossless decompression core for performing the lossless decompression on the image data in the compressed data, and a lossy decompression core for performing the lossy decompression on the image data in the compressed data.

6. The image processing apparatus according to claim 2 further comprising a decompression processing unit for performing lossless decompression and lossy decompression on compressed data, wherein
the decompression processing unit includes one DMA, a first lossless decompression core for performing lossless decompression processing on instruction data in the compressed data, a second lossless decompression core for performing the lossless decompression on the image data in the compressed data, and a lossy decompression core for performing the lossy decompression on the image data in the compressed data.

7. The image processing apparatus according to claim 3 further comprising a decompression processing unit for performing lossless decompression and lossy decompression on compressed data, wherein
the decompression processing unit includes one DMA, a first lossless decompression core for performing lossless decompression processing on instruction data in the compressed data, a second lossless decompression core for performing the lossless decompression on the image data in the compressed data, and a lossy decompression core for performing the lossy decompression on the image data in the compressed data.

8. The image processing apparatus according to claim 4 further comprising a decompression processing unit for performing lossless decompression and lossy decompression on compressed data, wherein
the decompression processing unit includes one DMA, a first lossless decompression core for performing lossless decompression processing on instruction data in the compressed data, a second lossless decompression core for performing the lossless decompression on the image data in the compressed data, and a lossy decompression core for performing the lossy decompression on the image data in the compressed data.
